(19) United States
(12) Patent Application Publication
(10) Pub. No.: US 2015/0381666 A1
(43) Pub. Date: Dec. 31, 2015

(54) VOICE COMMUNICATION SYSTEM AND SERVICE WITHIN A MULTI-PROTOCOL NETWORK

(71) Applicant: TAWQK CORPORATION LTD, Douglas (IM)

(72) Inventor: Ranjeet RUSTOGI, New York, NY (US)

(73) Assignee: TAWQK CORPORATION LTD, Douglas (IM)

(21) Appl. No.: 14/765,241

(22) PCT Filed: Jan. 30, 2014
(86) PCT No.: PCT/IB2014/058682

§ 371 Date: Jul. 31, 2015

Related U.S. Application Data
(60) Provisional application No. 61/759,221, filed on Jan. 31, 2013.

(51) Int. Cl. H04L 29/06; H04M 7/00

(52) U.S. Cl. CPC H04L 65/1069; H04L 65/1006; H04L 65/1033; H04M 7/006

(57) ABSTRACT

A voice communication system (500) comprises a globally distributed, universally accessible multi-protocol hosted platform (100), which may be used, for example, by a single user, group of users, a team, family or a small business. The system effectively enables subscribers to create an ad hoc micro PBX/phone system in the cloud, by arranging and organizing multiple contacts, multiple destinations per contact and calling groups with multiple contacts per group. Nested groupings provided in embodiments of the invention provide high levels of convenience, and an integrated multi-protocol framework for reachability of contacts, to create a comprehensive calling service with enhanced capabilities accessible from any subscriber device, or other voice communication device, across international borders.

### FIELD OF THE INVENTION

The present invention relates to telecommunications, and more particularly to the provision of voice communication services within a multi-protocol network environment.

### BACKGROUND TO THE INVENTION

In recent years, there has been a tremendous expansion and improvement in the modes and forms of communication. Innovation in the Internet and World Wide Web advances in telecommunications and network technology, along with the development of innovative endpoints and devices, has changed the way in which many people throughout the world communicate.

However, despite the many new forms of communication available, voice telephony remains the most effective, efficient and satisfying means of communication for many purposes. Nevertheless, the main innovations which have occurred in the field of voice telephony have been the development of cellular/wireless technology, and Internet telephony, or Voice over Internet Protocol (VoIP), both of which are now over a decade old.

While VoIP technology has been able to provide advanced feature-rich telephony at reasonable cost, it is not without shortcomings. Fixed VoIP requires subscribers to install, configure and support a VoIP-enabled endpoint, such as an analog telephone adaptor (ATA) or a VoIP gateway in their premises. While improvements in auto-provisioning technologies have eliminated many of the configuration problems, installation and quality of service (QoS) issues have continued to plague most fixed VoIP deployments and tie the user to a particular location, e.g. to their home or office

Software-based clients installed on a personal computer eliminate the configuration/provisioning woes to an extent. Furthermore, installation on a laptop or portable computer provides the user with some mobility. However, this still requires a level of knowledge to configure/use the client software effectively, does not eliminate dependence on availability of and access to the Internet, and for a good call experience requires the use of a good quality headset with built in microphone to alleviate any noise, echo and feedback issues.

VoIP and similar services are also available through ‘apps’ on smart phones and other portable devices. Such services include Skype, Viber, KakaoTalk, Nimbuzz, Tango, and so forth, as well as other VoIP clients.

These mobile apps, along with the availability of high-performance carrier-grade open source telecommunications platforms, has led to the emergence of a large number of cut-rate Internet-based calling services. While such services may offer considerable savings on long-distance calling costs, they require subscribers to own and carry a sophisticated (and expensive) smart device, and require access to a data network either through a mobile/cellular service provider (at additional cost), or to a Wi-Fi network. All such services offer substantially the same features and/or services, such as free calls between users of their service, instant messaging, group messaging and exchange of pictures. Some also allow discounted calls to mobile or landline phones, but still require access to the Internet in the same way as a fixed-line VoIP device.

Despite improvements in a diverse set of technologies highlighted above. including wireless and wired network technologies and services, endpoints and software, each of these elements has dependencies and hence is limited, unreliable and inflexible. Furthermore, due to the nature of these networks, the plain old telephony service (POTS), as provided by established telecommunications carriers continues to be the most stable, reliable and ubiquitous voice communications option. However, POTS continues to suffer from disadvantages, largely stemming from its status as a legacy service. For example, relatively high tariffs are generally charged by the incumbent carriers, and in particular high roaming charges are often applied on international mobile/cellular networks. Calling card services emerged a few decades ago to provide relief in the form of discount tariffs for international calls while allowing the use of the same reliable POTS service. However, these services are generally cumbersome and inconvenient to use, provide no value-added service and do not deliver the same call reliability as a carrier-supported international call. Furthermore, there are concerns of unethical and dishonest practices within the industry, such as the application of connection charges, six-minute rounding, and deliberate call disconnection, requiring the customer to call again and to pay additional connection charges. These questionable practices are designed to recover the cost of the discount offered on the per-minute call charges.

Smart phones provide a high degree of value-added service, including integrated contacts, geo-location, information, messaging, Internet access, and so forth. However, smart phones create high levels of user dependency on extremely important and sensitive information such as contacts and other information stored within their memory. This becomes a problem due to the fact that these devices commonly have limited battery life, are not always particularly robust to mechanical shocks, and are prone to loss and/or theft

Taking into account the above circumstances, it would be desirable to provide a voice communications service which is accessible via a range of devices and technologies (including POTS), provides an attractive and affordable cost and charging structure, supports central storage of contacts, and is able to support a range of value-added telephony features and services. An ultimate objective of such a service, towards which embodiments of the present invention aspire, is to provide calling to/from any number, through any endpoint, via any service, using any protocol, and with any communications technology.

### SUMMARY OF THE INVENTION

In one aspect, the invention provides a multi-protocol communications switching system comprising:

a service switching point (SSP) interfaced with an Internet Protocol (IP) network, and configured to accept, switch and initiate Voice over IP (VoIP) telephony calls;

a multi-protocol gateway apparatus (MPGW) interfaced with the IP network, and configured to accept, switch and initiate communications sessions based upon one or more of a plurality of configured protocols, and to convert communications session data and signalling messages between the configured protocols; and

a service control point (SCP) interfaced with the SSP and the MPGW, and configured to accept and initiate VoIP telephony calls via the SSP, to accept and initiate communications sessions via the MPGW, and to bridge VoIP telephone call data and communications session data between the SSP and the MPGW.

Advantageously, a system embodying the invention is thereby able to connect calls between disparate networks, using multiple different protocols. Furthermore, such a system is able to direct long-distance transport of connections via the IP network, thereby providing reduced costs when compared with prior art services providing transport via dedicated networks.

According to embodiments of the invention, signalling across the interface between the SSP and SCP and across the interface between the MPGW and the SCP, is based upon a common signalling protocol. This advantageously enables calls to be bridged between different networks and/or different protocols using common a common bridging system, with all communications between the SSP, SCP and MPGW requiring only a single protocol. Responsibility for all protocol conversion and translation may be restricted to the MPGW, which may be implemented as a single server or a local or distributed farm of servers, resulting in simplified management and high levels of scalability.

The common signalling protocol may be Session Initiation Protocol (SIP).

The plurality of configured protocols of the MPGW may include a VoIP telephony protocol comprising SIP signalling, and one or more alternative voice communications protocols,

wherein the SSP, SCP and MPGW are configured to establish a first VoIP telephony session between the SSP and the SCP and to establish a second VoIP telephony session between the MPGW and the SCP,

wherein the MPGW is configured to convert communications session data between the alternative voice communications protocols and the VoIP telephony protocol, and

wherein the SCP is configured to bridge the first VoIP telephony session and the second VoIP telephony session.

In embodiments of the invention, the alternative voice communications protocols comprise one or more of a Skype protocol and an Extensible Messaging and Presence Protocol (XMPP).

In some embodiments, the SCP is configured to instantiate a back-to-back user agent (B2BUA) entity which is adapted to terminate and bridge the first and second VoIP telephony sessions.

The plurality of configured protocols of the MPGW may include first and second distinct communications protocols,

wherein the SCP and MPGW are configured to establish a first communications session between the MPGW and the SCP corresponding with the first communications protocol, and to establish a second communications session between the MPGW and the SCP corresponding with the second communications protocol, wherein the first and second communications sessions use the common signalling protocol,

wherein the MPGW is configured to convert communications session data between the alternative voice communications protocols and the VoIP telephony protocol, and

wherein the SCP is configured to bridge the first VoIP telephony session and the second VoIP telephony session.

According to embodiments of the invention, the system may further comprise a Service Data Point (SDP) interfaced with the SCP, the SDP comprising a database containing at least subscriber information and service information.

The system may also comprise a Billing/Operational Support System (B/OSS) which is interfaced with the SCP and configured to provide call processing and control services to the SCP. The call processing and control services for which the B/OSS is configured may comprise one or more of: instructing the SCP to prompt for user input; instructing the SCP to capture user input; determining connection parameters; and instructing the SCP to establish a connection. The B/OSS may also be configured to log connection information and to update subscriber billing information.

In some embodiments, the system further comprises at least one media server, which is interfaced with the SCP and configured to perform one or more media support functions. The media support functions may comprise one or more speech functions, such as: storage and provision of pre-recorded audio prompts; text to speech (TTS) conversion; and/or an automated speech recognition (ASR) function.

The system may also comprise at least one web server interfaced to the B/OSS and accessible via the internet, wherein the web server is configured to provide access to customer information maintained by the B/OSS via a web-based interface. The web server may be configured to provide network operator access to perform supervisory and management functions. The web server may also be configured to provide customer access to provide service and billing functions, wherein the service and billing functions comprise one or more of: reviewing call history; viewing customer account configuration, settings and preferences; updating customer account configuration, settings and preferences; viewing customer billing information; and making payments.

In another aspect, the invention provides a method of multi-protocol communications switching comprising:

receiving, via an internet protocol (IP) network, an incoming call request initiated from a call originating endpoint and formatted in accordance with a first one of a plurality of predetermined protocols, wherein the predetermined protocols include a Voice over IP (VoIP) telephony protocol;

establishing a first telecommunications channel with the call originating endpoint;

receiving, from the call originating endpoint, information identifying at least one call destination endpoint associated with one or more of the plurality of predetermined protocols;

initiating, via the IP network, an outgoing call request directed to the call destination endpoint and formatted in accordance with a second one of the plurality of predetermined protocols; and

establishing a second telecommunications channel with the call destination endpoint; and

bridging the first and second telecommunications channels to establish a connection between the call originating endpoint and the call destination endpoint.

The first and second ones of the plurality of predetermined protocols may be dissimilar, and the method then further comprises translating communications session data transported via the connection between the call originating endpoint and the call destination endpoint between the first and second ones of the plurality of predetermined protocols. The plurality of predetermined protocols may further comprise, for example, one or more of a Skype protocol and an Extensible Messaging and Presence Protocol (XMPP).

The information received from the call originating endpoint may identify a plurality of call destination endpoints, in which case the method may advantageously employ one or more of a number of strategies in order to initiate a connection to a single destination endpoint, or to initiate connections to multiple endpoints (i.e. to create a conference bridge).

According to one strategy, initiating an outgoing call request comprises sequentially initiating an outgoing call request to each one of the plurality of call destination endpoints, and establishing a second telecommunications channel with a first call destination endpoint to accept a respective outgoing call request. This is termed a ‘hunt’ strategy herein, due to the fact that it attempts a number of destinations sequentially to try to establish a connection, and stops if/when successful.

According to another strategy, initiating an outgoing call request comprises simultaneously initiating an outgoing call request to each one of the plurality of call destination endpoints, and establishing a second telecommunications channel with a first call destination endpoint to accept a respective outgoing call request. This is termed a ‘blast’ strategy herein, due to the fact that it attempts a number of destinations simultaneously to try to establish a connection, and stops if/when a first destination picks up.

Advantageously, the method may be employed to create a conference bridge, by waiting to determine whether more than one destination picks up, and establishing at least a third telecommunications channel with a second call destination endpoint to accept a respective outgoing call request, and bridging the third telecommunications channel with the first and second telecommunications channels to establish a conference connection between the call originating endpoint, the first call destination endpoint and the second call destination endpoint.

According to embodiments of the invention, information identifying at least one call destination endpoint comprises an identifier of a corresponding set of predefined calling rules stored in a database, wherein the method comprises retrieving the predefined calling rules from the database, and initiating an outgoing call request comprises initiating one or more outgoing call requests to one or more corresponding call destination endpoint in accordance with the predefined calling rules.

In another aspect, the invention provides a system for caller-initiated telecommunications connection processing comprising a service control point (SCP) interfaced directly or indirectly with an Internet Protocol (IP) network and configured to accept and initiate telecommunications connections via the IP network, a database accessible via the SCP and containing calling rules associated with one or more subscribers. The SCP is configured to:

receive an incoming call request from a call originating endpoint;

establish a first telecommunications channel with the call originating endpoint;

identify a subscriber associated with the incoming call request;

receive, from the subscriber, information identifying one or more associated calling rules;

retrieve, from the database, the one or more associated calling rules;

establish at least a second telecommunications channel with a first call destination endpoint in accordance with the one or more associated calling rules; and

bridge the first and second telecommunications channels to establish a connection between the call originating endpoint and the first call destination endpoint.

In embodiments disclosed herein, the calling rules comprise hierarchical contact information arranged in logical tables. For example, multiple destination endpoints (i.e. mobile or fixed-line telephones/numbers, Skype addresses, and so forth) may be associated with an individual, and compiled into a logical table termed a ‘Personal Access List’ (PAL). A PAL can be used to contact the associated individual in an automated fashion, be sequentially or simultaneously attempting to establish a connection with each listed endpoint.

As a higher level of the hierarchy, logical tables termed ‘pools’ may contain lists of PALs and/or individual destination endpoints. Pools generally represent groups of associated individuals whom the subscriber may wish to contact as alternatives (e.g. members of a team), or simultaneously (e.g. via a conference bridge). Of course, the use of PALs and pools need not be constrained to these particular purposes, and individual subscribers may choose to use these facilities for their own different purposes.

More generally, in some embodiments the calling rules contained within the database comprise one or more access list data structures, each access list data structure being associated with a subscriber and an identifying code, and including a collection of one or more destination endpoint identifiers, whereby the information identifying the one or more associated calling rules comprises a corresponding received code identifying a subscriber access list data structure, and the SCP is configured to establish the second telecommunications channel by identifying and initiating an outgoing call request with the first call destination endpoint using a destination endpoint identifier selected from the collection associated with the subscriber access list data structure in accordance with an access list calling policy.

As noted above, the access list calling policy may be a hunt policy, whereby the SCP is configured to establish the second telecommunications channel by sequentially initiating an outgoing call request to each one of the call destination endpoints identified in the collection associated with the received code, and establishing a second telecommunications channel with a first call destination endpoint to accept a respective outgoing call request.

Alternatively, the access list calling policy may be a blast policy, whereby the SCP is configured to establish the second telecommunications channel by simultaneously initiating an outgoing call request to each one of the call destination endpoints identified in the collection associated with the received code, and establishing a second telecommunications channel with a first call destination endpoint to accept a respective outgoing call request.

Furthermore, the calling rules contained within the database may comprise one or more pool list data structures, each pool list data structure being associated with a subscriber and an identifying code, and including a collection of one or more entries each of which comprises a destination endpoint identifier or an access list data structure identifier, whereby the information identifying the one or more associated calling rules comprises a corresponding received code identifying a subscriber pool list data structure, and the SCP is configured to establish the second telecommunications channel by identifying and initiating an outgoing call request with the first call destination endpoint using a destination endpoint identifier selected via the collection of entries associated with the subscriber pool list data structure in accordance with a pool list calling policy.

The pool list calling policy may be a hunt policy, or a blast policy

In still another aspect, the invention provides a method of caller-initiated telecommunications connection processing comprising:

receiving an incoming call request from a call originating endpoint;

establishing a first telecommunications channel with the call originating endpoint;

identifying a subscriber associated with the incoming call request;

receiving, from the subscriber, information identifying one or more associated calling rules held within a database;

retrieving, from the database, the one or more associated calling rules

establishing at least a second telecommunications channel with a first call destination endpoint in accordance with the one or more associated calling rules; and

bridging the first and second telecommunications channels to establish a connection between the call originating endpoint and the first call destination endpoint.

In another aspect, the invention provides a system for caller-initiated conference calling comprising a service control point (SCP) interfaced directly or indirectly with an Internet Protocol (IP) network and configured to accept and initiate telecommunications connections via the IP network, and a database accessible via the SCP and containing calling group information associated with one or more subscribers, wherein the SCP is further configured to:

receive an incoming call request from a call originating endpoint;

establish a first telecommunications channel with the call originating endpoint;

identify a subscriber associated with the incoming call request;

receive, from the subscriber, information identifying an associated calling group;

retrieve, from the database, the associated calling group information;

establish a plurality of conference telecommunications channels

each having a call destination endpoint identified in the associated calling group information; and

bridge the first telecommunications channel with the plurality of conference telecommunications channels to establish a conference connection comprising the first telecommunications channel and the plurality of conference telecommunications channels.

In a still further aspect, the invention provides a method of caller-initiated conference calling comprising:

receiving an incoming call request from a call originating endpoint;

establishing a first telecommunications channel with the call originating endpoint;

identifying a subscriber associated with the incoming call request;

receiving, from the subscriber, information identifying an associated calling group, wherein calling group information associated with the subscriber is held within a database;

retrieving, from the database, the associated calling group information;

establishing a plurality of conference telecommunications channels each having a call destination endpoint identified in the associated calling group information; and

bridging the first telecommunications channel with the plurality of conference telecommunications channels to establish a conference connection comprising the first telecommunications channel and the plurality of conference telecommunications channels.

According to a further aspect the invention provides a method in a service control point (SCP) of transferring an endpoint of an established call between two or more parties, at least one of which is a subscriber to a service provided by the SCP, from a first communications device to a second communications device of a transferring party, the method comprising:

the SCP receiving, from the subscriber, a request to transfer the call from the first device;

the SCP receiving, from the subscriber or the transferring party, identifying information of at least one candidate communications device;

the SCP initiating one or more outgoing call requests to the at least one candidate communications device;

the SCP receiving an acceptance of one of the outgoing call requests from a second communications device selected from the at least one candidate communications device; and

associating the telecommunications channel with the second communications device, and disassociating the telecommunications channel with the first communications device, in order to transfer the call.

In accordance with this aspect of the invention, the transferring party is a party whose endpoint is to be transferred from the first device to the second device. As will be appreciated, in a conventional scenario the term ‘transferring party’ will normally refer to the party initiating a transfer, which typically will be the same party whose endpoint is to be transferred. However, embodiments of the present invention may enable one party to an established call to initiate a transfer to occur at an endpoint corresponding with another party to the call.

According to a related aspect the invention provides a method in a service control point (SCP) of transferring an endpoint of an established call between two or more parties, at least one of which is a subscriber to a service provided by the SCP, from a first communications device to a second communications device of a non-subscriber transferring party, the method comprising:

the SCP receiving, from the non-subscriber transferring party, a request to transfer the call from the first device;

the SCP receiving, from the non-subscriber transferring party, identifying information of at least one candidate communications device;

the SCP initiating one or more outgoing call requests to the at least one candidate communications device;

the SCP receiving an acceptance of one of the outgoing call requests from a second communications device selected from the at least one candidate communications device; and

associating the telecommunications channel with the second communications device, and disassociating the telecommunications channel with the first communications device, in order to transfer the call.

In this aspect, the fact that at least one party to the established call is a subscriber to a service provided by the SCP enables all parties to the call to gain access to a call transfer feature of the service.

According to another aspect, the invention provides a method of charging for access to a communications service wherein the communications service provides interconnection between endpoints located on disparate networks, the method comprising:

receiving an incoming call request initiated by a first subscriber from a call originating endpoint on a first communications network;

receiving, from the call originating endpoint, information identifying a call destination endpoint on a second communications network;

establishing a connection between the call originating endpoint and call destination endpoint;

metering the connection to determine an associated cost comprising one or more of: a cost associated with use of the first communications network; a cost associated with use of the second communications network; and a cost associated with provision of interconnection between the first and second networks;

determining a charge for access to the communications service by the subscriber based upon the associated cost;

in the event that the call destination endpoint is associated with a second subscriber of the communications service, applying a reduction to the determined charge; and

recording the charge in a database in association with an account record of the first subscriber.

The reduction to the determined charge may be based, for example, upon a percentage.

In another aspect, the invention provides a system for caller-initiated telecommunications connection scheduling comprising a service control point (SCP) interfaced directly or indirectly with an Internet Protocol (IP) network and configured to accept and initiate telecommunications connections via the IP network, wherein the SCP is further configured to:

receive a call scheduling request from a requesting subscriber, the scheduling request comprising call originating endpoint information scheduling information and call destination endpoint information, and

wherein the SCP is further configured to, in accordance with the scheduling information:
establish a first telecommunications channel with the call originating endpoint;
establish at least a second telecommunications channel with a first call destination endpoint in accordance with the call destination endpoint information; and
bridge the first and second telecommunications channels to establish a connection between the call originating endpoint and the first call destination endpoint.

The system may further comprise a database accessible via the SCP and containing calling rules associated with one or more subscribers, wherein the call destination endpoint information identifies one or more calling rules associated with the requesting subscriber, and wherein the SCP is configured to:

retrieve, from the database, the one or more associated calling rules; and

establish at least the second telecommunications channel with the first call destination endpoint in accordance with the one or more associated calling rules.

The scheduling information may indicate that the connection is to be initiated immediately. Alternatively, the scheduling information may indicate that the connection is to be initiated at a specified future time. The scheduling information may indicate that the connection is to be initiated at a plurality of specified future times, e.g. according to a timetable or a periodic schedule.

The system may further comprise a web server configured to receive call originating endpoint information scheduling information and call destination endpoint information from the subscriber via a web-based interface, and to generate and forward the call scheduling request to the SCP. The system may also comprise an SMS or instant message gateway, via which the call scheduling request is received.

In a further aspect, the invention provides a method of caller-initiated telecommunications connection scheduling comprising:

receiving a call scheduling request from a requesting subscriber, the scheduling request comprising call originating endpoint information scheduling information and call destination endpoint information; and

in accordance with the scheduling information:
establishing a first telecommunications channel with the call originating endpoint;
establishing at least a second telecommunications channel with a first call destination endpoint in accordance with the call destination endpoint information; and
bridging the first and second telecommunications channels to establish a connection between the call originating endpoint and the first call destination endpoint.

Further features, benefits and advantages of the invention, in its various aspects, will now be described with reference to particular embodiments, which are intended to illustrate and exemplify the principles of the invention, without limiting its scope as defined in the statements above, and in the claims appended hereto.

### BRIEF DESCRIPTION OF THE DRAWINGS

Embodiments of the invention will now be described with reference to the accompanying drawings, in which like reference numerals refer to like features, and wherein:

FIG. 1 shows schematically a multi-protocol communications switching system according to an embodiment of the invention;

FIG. 2 is a block diagram illustrating a general principle of connecting a SIP-originating call to a SIP endpoint within the system of FIG. 1;

FIG. 3 is a block diagram illustrating a general principle of connecting a SIP-originating call to a non-SIP endpoint within the system of FIG. 1;

FIG. 4 is a block diagram illustrating a general principle of connecting a non-SIP originating call to a non-SIP endpoint within the system of FIG. 1;

FIG. 5 is a network schematic diagram illustrating how the multi-protocol switching system may be deployed within a wider communications network, according to embodiments of the invention;

FIG. 6 is a flowchart illustrating the general operation of a call establishment function according to embodiments of the invention;

FIG. 7 is a flowchart illustrating a general process of creating connections using subscriber-defined PALs and pools embodying the invention;

FIG. 8 is a flowchart illustrating a PAL hunt strategy;

FIG. 9 is a flowchart illustrating a PAL blast strategy;

FIG. 10 is a flowchart illustrating a pool hunt strategy;

FIG. 11 is a flowchart illustrating a pool blast strategy;

FIG. 12 is a flowchart illustrating a pool conference call strategy; and

FIG. 13 is a flowchart illustrating a general connection procedure adopted within the multi-protocol communications switching system.

### DETAILED DESCRIPTION OF EMBODIMENTS

Embodiments of the present invention may be concisely described as providing a cloud-based telephony service, which is highly configurable, and allows users to build personal phone systems via a network-based server which is accessible from anywhere in the world, without the restriction of endpoints, underlying network, protocol or service. Embodiments may provide the rich feature set and cost benefits of VoIP without necessarily requiring access to the Internet, Wi-Fi, 3G/4G/LTE networks, and without a data connection, smart phone and/or installed app.

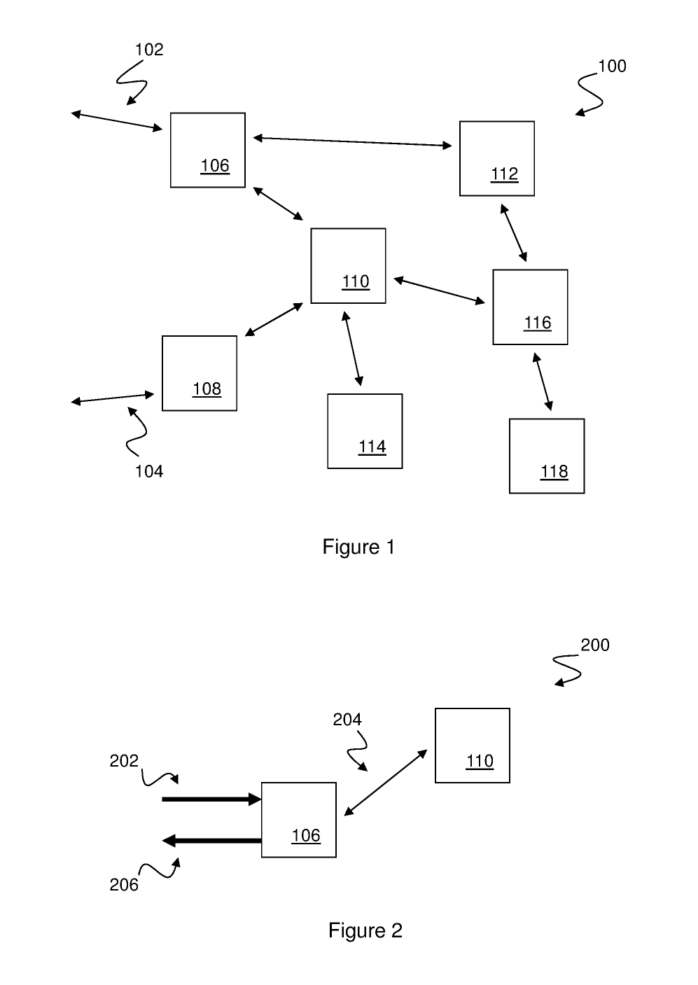

FIG. 1 shows schematically a multi-protocol communications switching system 100 according to an embodiment of the invention. The system 100 is configured to accept, switch and initiate Internet-based voice calls 102 managed using the Session Initiation Protocol (SIP). The system 100 is also configured to accept, switch and initiate non-SIP calls 104, such as Skype calls and Google Talk calls. As will be appreciated from the following more-detailed description of the components and operation of the system 100, these examples of non-SIP calls are not limiting, and the system 100 can be readily adapted and configured to handle calls originating or terminating at other types of endpoint, via different services and protocols.

Switching of SIP-based voice calls is handled by a Service Switching Point (SSP) 106, i.e. a VoIP switch. As will be known to persons skilled in the telecommunications arts, the SSP itself is a conventional endpoint which is able to route calls to, and communicate with, other SSPs using an appropriate messaging protocol. In conventional Intelligent Network (IN) application, the protocol most-commonly used is Signalling System No. 7 (SS7). However, embodiments of the present invention may use SIP as the primary protocol, with other protocols being employed as required for communications with non-SIP endpoints, as described further below. The SSP 106 is thus able to manage the switching of all SIP-based VoIP calls into and out of the communications switching system 100.

Switching and processing of non-SIP calls is handled by a multi-protocol gateway (MPGW) 108. Features and operations of the MPGW 108 will be described in greater detail below with reference to FIGS. 2 to 4 and 13. In general, however, the function of the MPGW 108 is to handle calls entering and/or leaving the communications switching system 100 other than SIP-based VoIP calls. For example, the MPGW 108 is responsible for processing and switching of Skype calls, Google Talk calls, and so on. For example, an incoming Skype call can be received by the MPGW 108, which processes the call and associated messages and parameters in order to determine information such as the source of the call, and converts this information into a corresponding SIP format, which is used for internal communication within the system 100 as described in greater detail below. Similarly, the MPGW 108 is responsible for the processing required to convert SIP calls directed to non-SIP endpoints.

The multi-protocol communications switching system 100 further includes a Service Control Point (SCP) 110. In the presently-disclosed embodiment, the SCP 110 is conveniently configured to communicate with the SSP 106 using SIP. However, persons skilled in the telecommunications arts will appreciate that other implementations may employ alternative procedures and protocols, for example those described in the Internet Engineering Task Force (IETF) Request For Comments no. 3976 (RFC 3976), entitled ‘Interworking SIP and Intelligent Network (IN) Applications’. In order to achieve compatibility between the MPGW 108 and the SCP 110, the MPGW 108 is also configured to communicate with the SCP 110 via SIP, and to convert between these protocols and the non-SIP protocols 104 which are supported by the multi-protocol switching system 100.

Also implemented within the SCP 110 is the functionality of back-to-back user agents (B2BUA). This enables the SCP 110 to terminate and originate calls entering and/or leaving the switching system 100 either as SIP calls 102 via the SSP 106, or as non-SIP calls 104 via the MPGW 108. As with other entities implemented within the SCP 110, a B2BUA communicates with both the SSP 106 and MPGW 108 using a single conventional set of procedures and protocols, e.g. SIP, the procedures and protocols specified in RFC 3976, or other suitable methods. Advantageously, therefore, the SCP may be configured to use only a single signalling protocol, such as SIP, with all necessary protocol conversions being handled by the MPGW.

The multi-protocol communications switching system 100 further includes a Service Data Point (SDP) 112, which is a database containing subscriber information, service information, and/or other data required for call processing. Data maintained by the SDP 112 may include subscriber personal information, contact numbers, calling preferences, and other service and subscriber-specific information, such as the information discussed in greater detail below with reference to Tables 1 to 4. The multi-protocol communications switching system 100 further includes a Business/Operational Support System (B/OSS) 116 supporting customer services such as signup, login, account configuration, taking orders, processing bills and collecting payments. In the presently-disclosed embodiment, the B/OSS 116 utilises the SDP 112 data store, and does not maintain its own separate database, although this is an option in alternative implementations. The B/OSS 116 presents an API layer for web-based configuration and management, provisioning and so forth. Additionally, the B/OSS 116 of the present embodiment houses a call processing/control engine for receiving requests from the SCP 110, determining the destinations, route, and other call parameters, and then instructing the SCP 110 accordingly. Instructions provided by the B/OSS 116 to the SCP 110 include, for example, to play a prompt, capture digits, make a call, and so forth. Information managed by the B/OSS 116 is accessed and updated by the SCP 110, for example at connection and termination of calls, for the purposes of logging call information and/or updating billing information. A web server 118 is configured to provide access to customer information maintained by the B/OSS 116 remotely via the Internet. The web server interface may be used by network operators for supervisory and management functions, and/or may be made available for use by individual customers to provide online access to their billing information. For example, customers may be permitted to review call histories, their current account configuration, settings and preferences, as well as to view and/or pay bills, or make prepayments, from a conventional web browser.

The multi-protocol switching system 100 further includes one or more media servers 114. The media servers provide media support to the SCP 110, such as speech functions including Automated Speech Recognition (ASR) and Text To Speech (TTS). Accordingly, for example, if the SCP 110 wishes to play an audio prompt to a subscriber, it requests the required audio content from the media server 114. Audio prompts may be predetermined messages recorded by a human announcer, or they may be generated from text strings passed to the media server 114, for processing by a TTS function. Similarly, if the SCP 110 is configured to receive voice input, for example in response to an audio prompt, the spoken subscriber input is passed to the media server 114 for processing by an ASR function. With this form of support from the media server 114, the SCP 110 can be configured to guide a subscriber through various supported features and functions using a touchtone or voice-activated menu system.

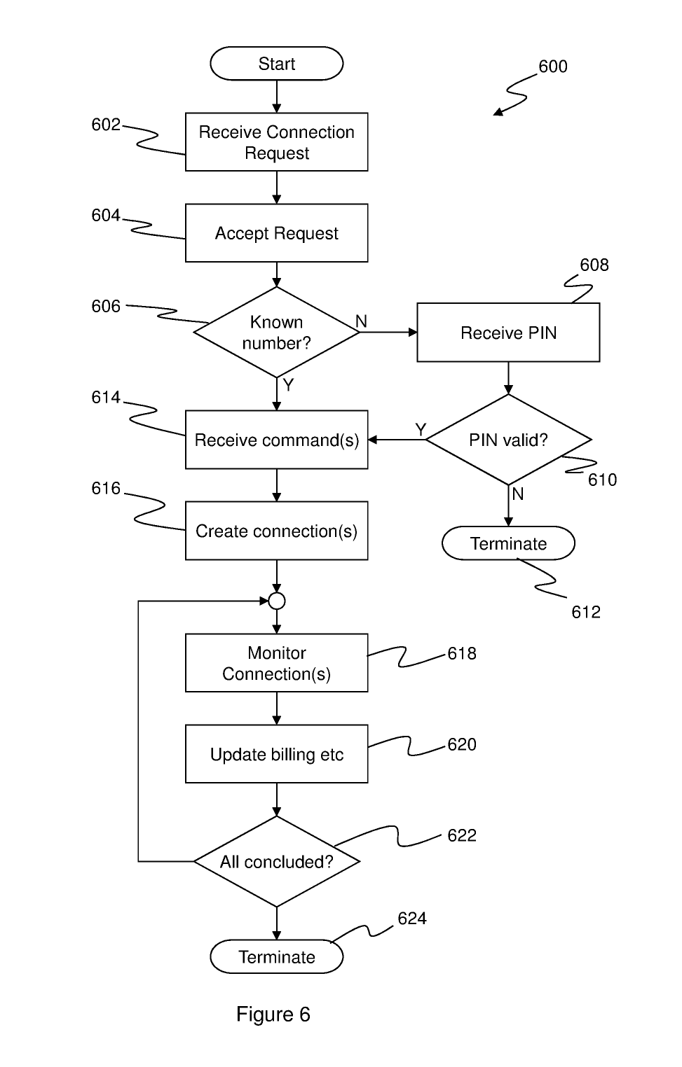

FIG. 2 is a block diagram 200 illustrating a general principle of connecting a SIP-originating call to a SIP endpoint within the system 100. An incoming SIP call request (i.e. an INVITE message) 202 is received by the SSP 106. The SSP processes the request, and communicates the corresponding call information (e.g. calling number/user, along with any other available information) to the SCP 110 via the communications channel 204. As described in greater detail below, particularly with reference to FIGS. 6 to 12, the SCP 110 will generally terminate the incoming call request 202, and interact with the user in order to establish the desired outgoing call or calls.

In the case that the desired ultimate endpoint is accessed via a SIP-based connection, the SCP 110 issues a corresponding connection request to the SSP 106, which routes the request appropriately as an outgoing SIP request 206. It should be noted that this includes all outgoing connections which are SIP-based from the perspective of the multi-protocol communication switching system 100, including calls which ultimately terminate, for example, within the public switched telephony network (PSTN), as well as calls (such as VoIP calls) which may use ‘native’ SIP from end-to-end.

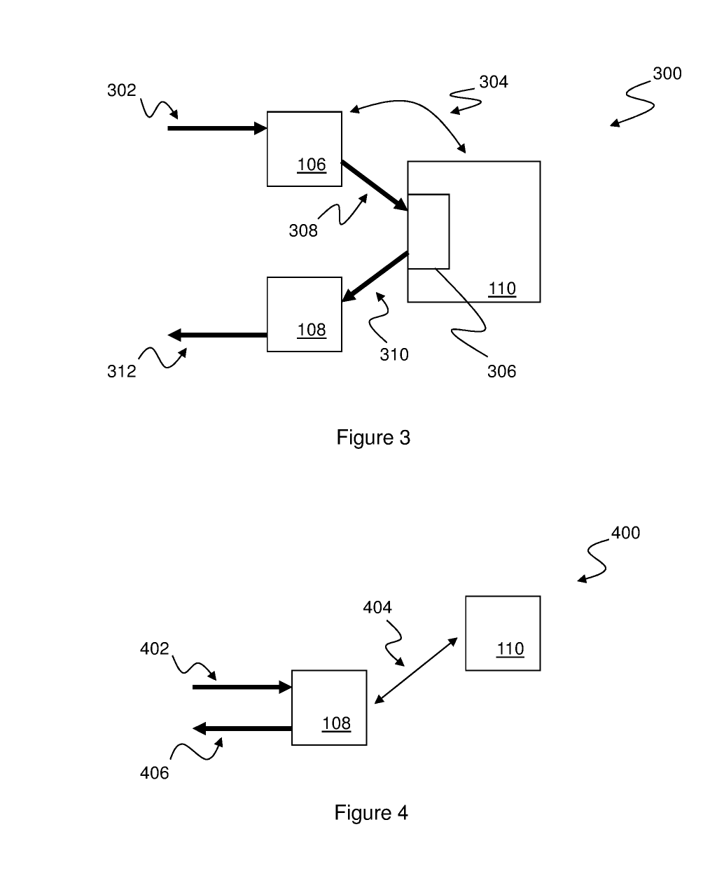

FIG. 3 is a block diagram 300 illustrating a general principle of connecting a SIP-originating call to a non-SIP endpoint within the system 100. An incoming SIP call request 302 is again routed to the SCP 110 by the SSP 106 via signalling communications channel 304. Through interaction with the user, the SCP 110 determines that an outgoing connection is to be established to a non-SIP endpoint, such as a Skype- or Google-Talk-enabled device. In order to bridge the call between the SSP 106 and the MPGW 108, the SCP 110 instantiates a B2BUA entity 306. The SCP 110 then directs the SSP 106 to connect the SIP call 302 through to the B2BUA 306 via communications channel 308. The B2BUA 306 further generates an outgoing SIP call request 310 to the MPGW 108, which performs the necessary processing in order to convert the request to the relevant protocol for the desired endpoint, e.g. to a Skype or Google Talk request 312. Accordingly, the SSP is unaware of the operation of the MPGW, viewing each outgoing connection as a SIP-based call to a respective B2BUA. In the presently-disclosed embodiment, the same procedure is used for calls between SIP endpoints, i.e. the incoming and outgoing connections 202, 206 shown in FIG. 2 are bridged within the SCP 110 via a B2BUA entity instantiated for this purpose.

FIG. 4 is a block diagram 400 illustrating a general principle of connecting a non-SIP originating call to a non-SIP endpoint within the system 100. The non-SIP incoming call 402, such as a Skype or Google Talk call, is received and processed by the MPGW 108, which exchanges corresponding SIP signalling messages with the SCP 110 via the channel 404. Through interaction with the end-user the SCP determines that the desired ultimate call destination is a non-SIP endpoint, such as a Skype or Google Talk endpoint, and directs the MPGW 108 to make a suitable connection request 406 to the intended endpoint.

In the presently-disclosed embodiment, the incoming 402 and outgoing 406 connections are routed via the MPGW 108, as illustrated in the block diagram 400. In other embodiments, however, modifications may be made in order to improve overall performance and/or efficiency. For example, if the incoming 402 and outgoing 406 protocols are identical, e.g. correspond with Skype calls, an enhanced MPGW implementation may be configured to enable a direct connection to be established between the Skype endpoints, to avoid the need for ongoing transport and processing of call content via the MPGW 108, thereby reducing the necessary processing load.

Additional to the scenarios specifically described above with reference to FIGS. 2 to 4, it will be appreciated that calls may also be routed from non-SIP source endpoints to SIP destination endpoints, by processing the incoming call request as described with reference to FIG. 4, bridging the call via a B2BUA as described with reference to FIG. 3, and establishing the outgoing SIP call as described with reference to FIG. 2. Accordingly, the system 100 is able to support any protocol for which the MPGW 108 is configured, enabling in principle the achievement of the desired objective of providing calling to/from any number, through any endpoint, via any service, using any protocol, and with any communications technology.

In some embodiments, the MPGW 108 may be implemented using conventional computer hardware, i.e. one or more microprocessors operatively associated with suitable volatile and non-volatile memories, along with communications and other peripheral interfaces, and configured to execute a suitable switching platform, such as the open-source FreeSWITCH platform, upon which the functionality of the MPGW 108, as described herein, may be implemented.

Similarly, the SCP 110 may be implemented as one or more server computing platforms, each having one or more central processing units and executing a suitable operating system software, which is programmed and configured to implement the functionality of the SCP 110, as described herein.

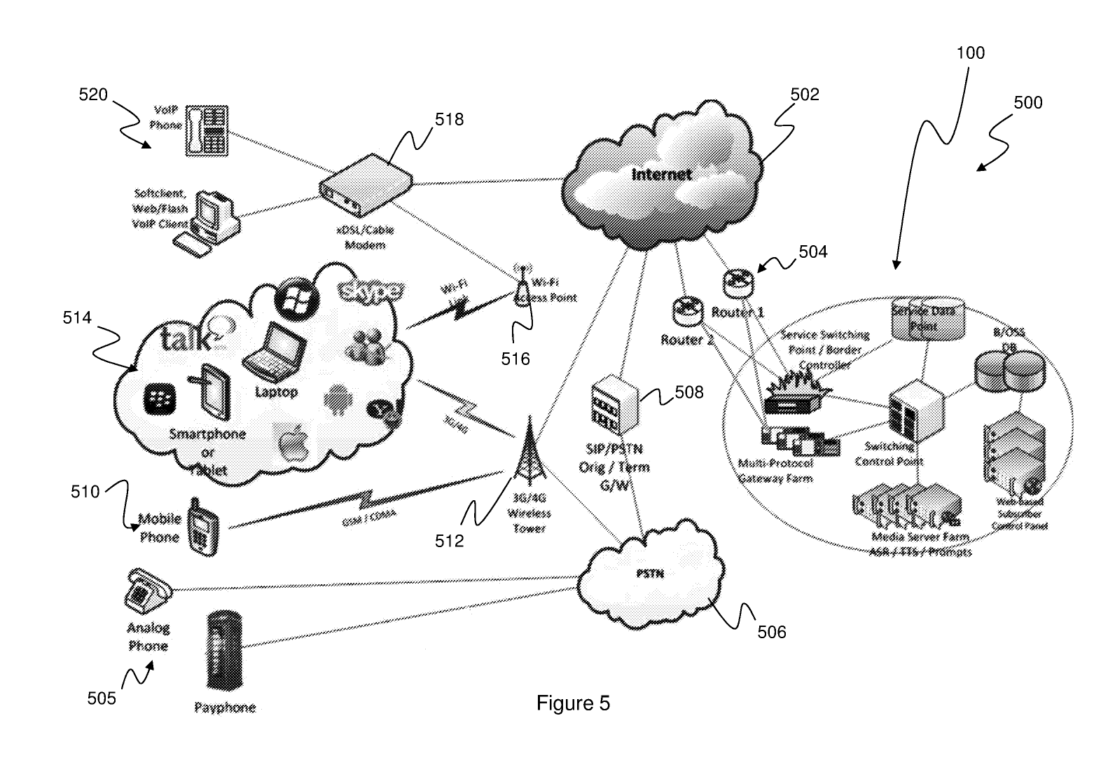

FIG. 5 is a network schematic diagram 500 illustrating how the multi-protocol switching system 100 may be deployed within a wider communications network, according to embodiments of the invention.

The multi-protocol switching system 100 is interconnected with the heterogeneous networks via the Internet 502. The connections to the internet 502 are established via one or more IP routers 504. All incoming and outgoing calls handled by the multi-protocol switching system 100, whether they be SIP-based calls, or non-SIP-based calls, are thus routed via the Internet 502. However, end-users of the system 100 are able to gain access using variety of different communications endpoint devices.

For example, a subscriber may access the system 100 via a conventional analog phone 505 connected to a public switched telephony network (PSTN) 506. The number dialled by the subscriber is routed by the PSTN 506 to a SIP/PSTN gateway 508, which establishes a SIP connection via the Internet 502 with the multi-protocol switching system 100. This establishes an initial connection through which the subscriber may communicate with the SCP 110, for example through a voice menu interface and/or touchtone interface, facilitated by ASR, TTS and/or other prompts served from the media server farm 114.

Alternatively, the subscriber may wish to access the multi-protocol switching system 100 via a mobile phone 510. A conventional mobile telephony connection is established via the PSTN 506 through a cellular mobile base station 512 proximate to the mobile phone 510. Communication with the SCP 110 then proceeds as for the fixed line case described above.

In yet another scenario, the subscriber may wish to access the multi-protocol switching system 100 via a smart phone or PC-based communications application, such as Skype or Google Talk. The user device 514 accesses the Internet via wireless protocols, such as a 3G or 4G (e.g. LTE or WiMAX) connection to a local cellular base station 512, or alternatively via a Wi-Fi link to a local Wi-Fi access point 516. In either case, the connection is routed via the Internet 502 to the multi-protocol switching system 100, and in particular to the MPGW 108. Routing to the Internet 502 may be via a carrier network from the base station 512, or may be via a broadband access device, such as a DSL or cable modem 518.

In yet another scenario, the subscriber may wish to access the multi-protocol switching system 100 from a hardware-based VoIP phone, from a software VoIP client 520 or from a software-based application on a mobile/handheld wireless internet-connected device such as a Smartphone or a Tablet computer 514. In this case, the VoIP call is routed via the broadband network interface 518, a private Wi-Fi access-point or public Wi-Fi Hotspot 516 or a 3G/4G wireless base station 512, via the Internet 502, and into the multi-protocol switching system 100, and more particularly to the SSP 106. In some cases, such as where a PSTN (Off-Net) service is provided by a VoIP service provider, the route between the VoIP client 520 and the SSP 106 may be via a SIP/PSTN gateway 508 to the PSTN 506, and then back via (the same or a different) gateway 508, before being routed via the internet 502 to the SSP 106. The difference between these scenarios is that, from the perspective of the SSP 106, in the first case the VoIP client 520 is the originating SIP endpoint for the incoming call, whereas in the second case the SIP/PSTN gateway 508 is the originating SIP endpoint.

In yet another scenario, a VoIP service provider (VSP) may look up an ENUM directory for calls made to regular phone numbers. As will be appreciated by the skilled person, an ENUM directory contains telephone number mappings, and may be maintained by the VSP, or may be provided as a publicly accessible service via the Internet. Regular phone numbers typically belong to endpoints on the PSTN and wireless networks (or on other VSP networks that provide their subscribers regular phone numbers to receive calls from the PSTN/Mobile networks), and require the VSP to execute a complex routing algorithm against their local routing table to pick an appropriate SIP/PSTN ‘gateway’ through which to route the call. The ENUM directory is an intelligent and rich database, which maps a dialled name/ID/number to a corresponding protocol-specific address at which the owner of the dialled phone number can be reached. With the various VoIP addresses (SIP, XMPP or Skype) registered for the multi-protocol system 500, a call from a user dialling its local access telephone number is routed free-of-charge via the Internet 502, instead of a paid SIP/PSTN ‘gateway’ 508.

This scenario may apply to the path for a call originated by a caller via a conventional analog phone device 505 connected to the PSTN 506 as well as a caller on a mobile device 510 connected via GSM/CDMA technology to a wireless tower 512 where the respective PSTN or wireless provider conducts an ENUM lookup similar to a VoIP service operator to avoid PSTN toll charges. If a mapping is found within the ENUM directory, the call is routed via the Internet 502 to the SSP 106, instead of the SIP/PSTN GW 508. From the perspective of the SSP 106, without an ENUM ‘lookup’ in each of the cases above, the SIP/PSTN gateway 506 is the originating SIP endpoint, whereas with an ENUM ‘look-up’, the originating endpoint for the incoming call is the SIP IP-IP Gateway/Proxy of the PSTN/Wireless provider.

In all of the above scenarios, it is important to appreciate that the subscriber uses a single number, or other relevant destination address, in order to contact the multi-protocol switching system 100. For example, from a conventional wired phone 505 or mobile phone 510 the subscriber will typically be supplied with a local telephone number, which, upon calling, is routed via the PSTN 506 and the SIP/PSTN gateway 508 to the multi-protocol switching system 100, thereby placing the subscriber in communication with the SCP 110. A similar locally or globally unique name or number may be used to contact the SCP 110 from a VoIP endpoint 520, or a non-SIP endpoint 514. At this stage, the subscriber has not specified their intended call destination. The destination is instead established via simple commands communicated to the SCP by the subscriber, for example using touchtone signalling, or through voice interactions, such as via ASR and TTS prompts. As a result of these commands, embodiments of which are described in greater detail below with reference to Tables 1 to 4 and FIGS. 6 to 13, one or more connections is established to call recipients at any type of endpoint supported by the multi-protocol switching system 100, e.g. a PSTN endpoint 505, a mobile telephony endpoint 510, a non-SIP application endpoint 514, or a SIP VoIP endpoint 520.

Furthermore, the connections established via the multi-protocol switching system 100 are primarily transported via the Internet 502. Only a ‘last mile’ portion of the connection is carried via a local subscriber network, such as a public telephony carrier, a cellular mobile service provider, or an Internet service provider (ISP). Accordingly, the cost of the connection to the end-user may be limited, for example to the cost of a local call. Additionally, while the connection itself is maintained and monitored by the multi-protocol switching system 100 it may be metered, and corresponding billing information of the subscriber updated within the B/OSS database 116. The cost of the service provided by the multi-protocol switching system 100 may be substantially lower than alternative long-distance and/or international calling rates via conventional telephony carriers and/or Internet telephony service providers. It is envisaged that substantial discounts may be available to subscribers, compared with existing services, after covering the costs of installing and maintaining the multi-protocol switching system 100, along with the communications costs associated with access to the Internet 502.

As mentioned above, embodiments of the multi-protocol communications switching system 100 are configured to accept connections from subscribers, to accept commands via touchtone and/or ASR input, and to establish connections with destination endpoints in accordance with the received commands. FIG. 6 is a flowchart 600 illustrating the general operation of the call establishment function according to embodiments of the invention.

Operation commences when the multi-protocol switching system 100 receives a connection request 602, in the form of a SIP call 102 or a non-SIP call 104. At step 604 the system responds by accepting the request, and creating an initial connection between the calling subscriber endpoint and the SCP 110.

According to embodiments of the invention, each subscriber has one or more calling numbers or identifiers associated with their account. Calls made to the system 100 from one of the registered numbers can be automatically associated with the corresponding subscriber account. Accordingly, at step 606 the SCP 110 checks subscriber records held in the SDP 112 to determine whether the calling number is known. If the number does not correspond with a registered number of any existing subscriber, then the SCP may initiate a procedure 608 to receive a PIN. In particular, each subscriber may have a unique identifying code (PIN) which can be used for calls made to the system 100 from unregistered endpoints, such as a payphone, or any other handset or voice-calling endpoint not owned and/or registered by the subscriber. At step 610, the SCP 110 compares the received PIN against records held in the SDP 112, to determine whether it is valid. If not, then the connection is terminated 612.

In the event that the incoming number (or other endpoint identifier) is recognised, or an entered PIN successfully validated, then at step 614 the SCP engages in a series of transactions with the subscriber endpoint in order to receive one or more commands which will determine the destination endpoint, or endpoints, for the required calling service. The receiving of commands at step 614 will typically involve presenting the subscriber with a menu of options, typically through the use of voice prompts. The subscriber may respond to the voice prompts using touchtone input (for example via a conventional wired or mobile telephone handset 505, 510), by voice input, interpreted using the ASR function of the media server 114, or alternatively via real-time text messaging, for example in a case where the originating endpoint is using the Skype protocol.

In the simplest case, operable from any endpoint device, the commands received at step 614 simply comprise an input string of digits and/or the * and # keys available on a conventional touchtone telephony device. The corresponding calling operations are determined by a look-up process in one or more tables associated with the subscriber account, and configured by the subscriber. Examples are discussed in greater detail below with reference to Tables 1 to 3.

Once the required destination endpoint, or endpoints, have been determined, the SCP 110 exchanges signalling messages with the SSP 106, and/or the MPGW 108 in order to initiate the required connections, as indicated by step 616 in the flowchart 600.

Assuming connections are successfully established, the SCP 110 subsequently monitors the calls in process (step 618), and updates billing and/or other records of the connection which may be maintained at the SDP 112 and/or the B/OSS 116. The SCP 110 determines (step 622) when all connections created at step 616 have been terminated by one or both endpoints, and at step 624 terminates the call, ensures that all associated records at the SDP 112 and B/OSS 116 are up to date, and then releases all resources associated with the connections.

As noted above, embodiments of the invention utilise logical tables which are configured by subscribers in order to create customised calling services. In the simplest case, these tables may be understood as contact lists, in which the subscriber can maintain a set of dialling codes, each of which is associated with a particular number or other endpoint address of a party whom the subscriber may wish to call. Entering one of these configured calling codes at step 614 of the establishment process 600 will then cause the SCP 110 to attempt to create a connection to the corresponding endpoint.

However, embodiments of the invention are configured to provide a more feature-rich service. Table 1 shows a logical visualisation of a ‘Personal Access List’ (PAL) table according to an embodiment of the invention. A PAL is generally a collection of telephone numbers and other endpoint addresses associated with an individual person. For example, a PAL table may contain one or more destination phone numbers, such as an office number and a mobile number, along with other addresses, such as a Skype identifier, or a Gmail address associated with a Google Talk service. Each one of these destination addresses is allocated an associated calling code, identified as a ‘Tawqk code’ in Table 1. Each one of these codes/destinations may have an associated priority, and an additional flag to indicate whether that address is currently active or not. The PAL table may also include an associated calling policy, which in embodiments of the invention may be a ‘hunt’ policy, a ‘blast’ policy, or other policy as defined and configured within the SCP 110. The function of the destination priority, and of the hunt and blast policies are described in greater

TABLE 1

| | Contact | | | | | | |
|---|---|---|---|---|---|---|---|
| Contact | Tawqk ™ | | | Tawqk ™ | | | |
| Name | Code | Destination | Alias | Code | Priority | Active | Policy |
| Roger | 15# | 61733585560 | Office | 151# | 2 | Y | Hunt |
| Moore | | 61412347456 | Mobile | 152# | 3 | N | |
| | | roger.moore | Skype | 153# | 1 | Y | |
| | | rm007@gmail.com | Google | 154# | 4 | Y | |
| | | | Talk | | | | |
| | | | XMPP | | | | |

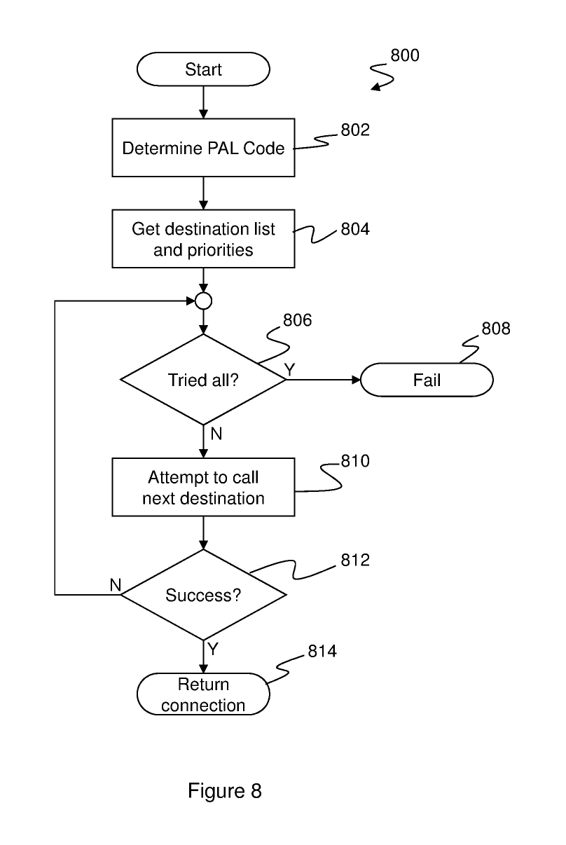

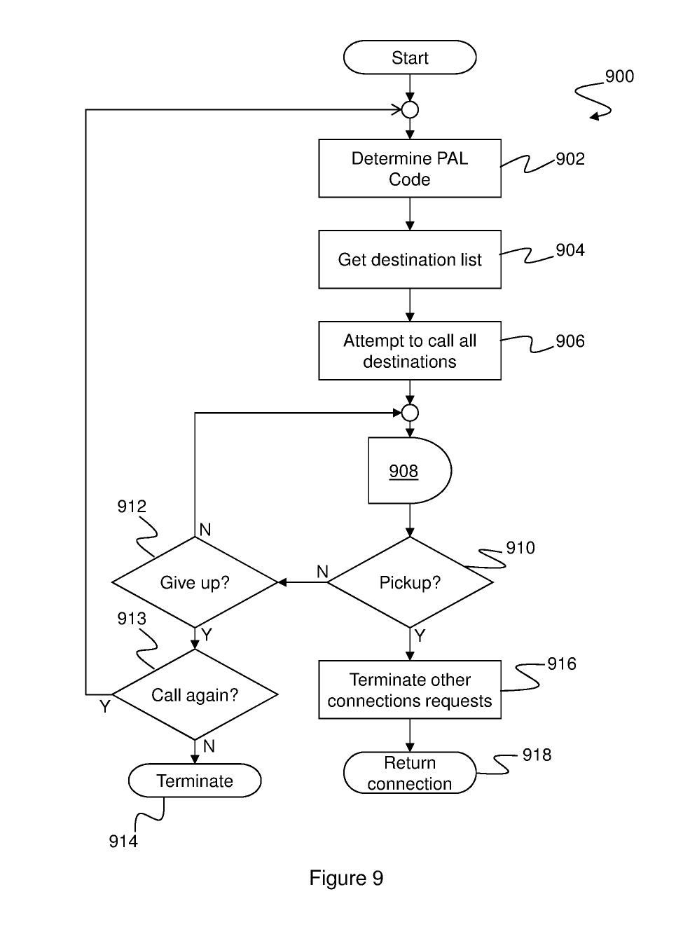

detail below, with reference to FIGS. 8 and 9 in particular.

The collection of destinations defined in the PAL table, e.g. Table 1, has an associated contact name, and an associated contact calling (Tawqk) code. The general concept is that the system 100 may be configured such that entry of the contact calling code alone by the subscriber is sufficient to enable the SCP 110 to attempt to connect with one or more of the specified destinations, in accordance with the defined policy, in an effort to track down the desired contact.

For example, in PAL Table 1, the associated contact calling code is ‘15#’, which will cause the SCP 110 to ‘hunt’ for the corresponding contact by attempting to connect to each of the destination numbers/addresses which is defined as active, according to the listed priority.

Further advanced features are provided in embodiments of the invention through the use of an expanded directory structure in which a number of contacts, each of which may have its own PAL table defined, are grouped together into larger collections identified herein as ‘pools’. A pool is a collection of ‘entities’, which may be PALs, selected individual destinations that belong to one or more PALs, or simply an arbitrary set of individual phone numbers (in the E.164 format), IDs and/or addresses in their appropriate formats for any of the protocols supported by the multiprotocol system 100 (e.g. Skype, Google Talk etc). In the following examples, it is generally assumed that a pool is a collection of PALs, since this represents a more powerful application of the pool concept. However, this is not intended to be limiting, and everything described in relation to pools of PALs should also be understood to apply, mutatis mutandis, in relation to pools comprising combinations of PALs and destinations, or indeed pools consisting solely of destinations. Destinations within a Pool may, but need not, belong to a PAL.

Table 2 shows a logical visualisation of a nested directory structure grouping together two PALs into a single pool. Each PAL has its own calling code. Each individual destination, when associated with a PAL, also has a distinct calling code composed of the same digits as its root, that make up the PAL calling code that owns it, plus one or more additional digits to distinguish it from other destinations belonging to the same PAL. Consequently, a unique PAL code produces a unique destination code offering easier identification, and improved manageability and automation. However, at a higher level of the defined hierarchy the pool has an identifying name, its own code (i.e. ‘1# in Table 2), its own calling policy, and its own priority listing for the individual entities that make up the pool.

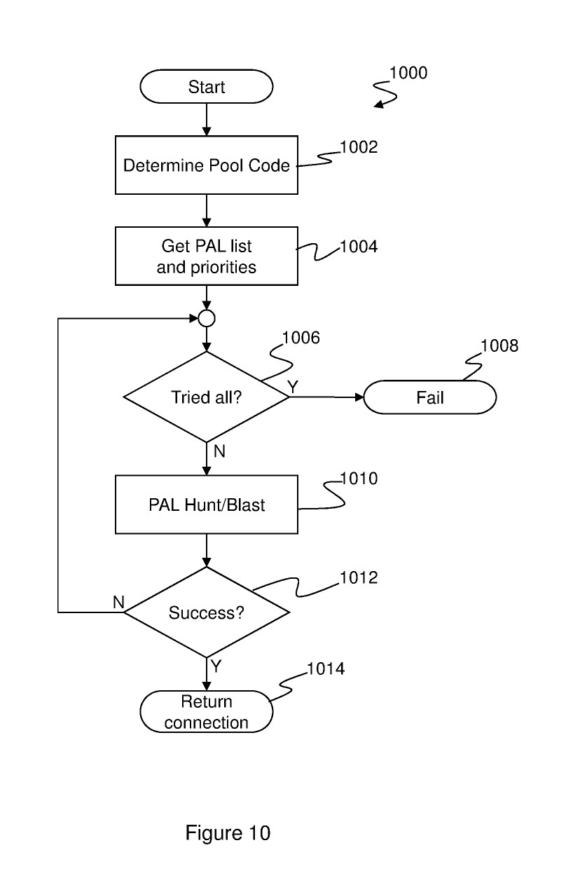

As described in greater detail below, in particular with reference to FIGS. 10 to 12, when a subscriber enters a pool code in response to prompts at step 614, the SCP 110 may hunt through the PALs in priority order, attempting to create a connection to each one of the contacts in turn. Alternatively, the SCP 110 may simultaneously call (‘blast’) all of the contacts defined by the PALs, and connect the calling subscriber to the first destination which responds. In yet a further alternative, the SCP 110 may attempt to contact all of the individuals identified by the PALs in the pool, and create a conference bridge between all responding endpoints.

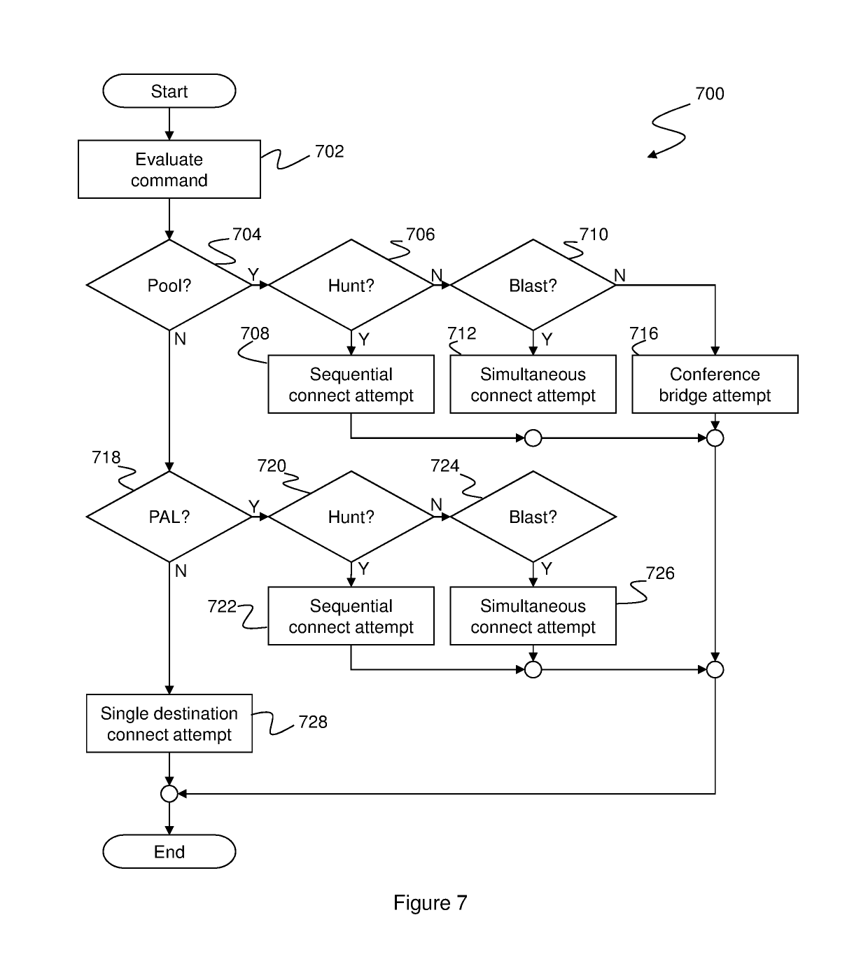

The general process of creating connections (i.e. step 616) using subscriber-defined PALs and pools is exemplified by the flowchart 700 shown in FIG. 7. At step 702 the SCP 110 evaluates the command provided by the subscriber. The command may specify a pool operation, a PAL operation, or a

TABLE 2

| | Pool | Pool | Pool | | PAL | | | Tawqk ™ | PAL | | PAL |
|---|---|---|---|---|---|---|---|---|---|---|---|
| Pool | Code | Policy | Priority | PAL | Code | Destination | Device Type | Code | Priority | Active | Policy |
| James | 1# | Hunt | 1 | Roger Moore | 15# | 61412347456 | Mobile | 152# | 3 | Y | Hunt |
| Bond | | | | | | rm007@gmail.com | Google Talk | 154# | 4 | Y | |
| | | | 2 | Sean Connery | 10# | 61733585665 | Office | 101# | 0 | Y | Blast |
| | | | | | | 61412344875 | Mobile | 102# | 0 | Y | |
| | | | | | | sean.connery | Skype | 103# | 0 | Y | |

single destination operation. In the case of a pool operation or a PAL operation, the command may specify a ‘hunt’ or ‘blast’ connection strategy. In the case of a pool operation, the command may additionally specify the creation of a conference call. If the command does not specify ‘hunt’, ‘blast’ or ‘conference’, then the appropriate calling strategy may be determined by looking up the default PAL policy and/or pool policy within the subscriber records.

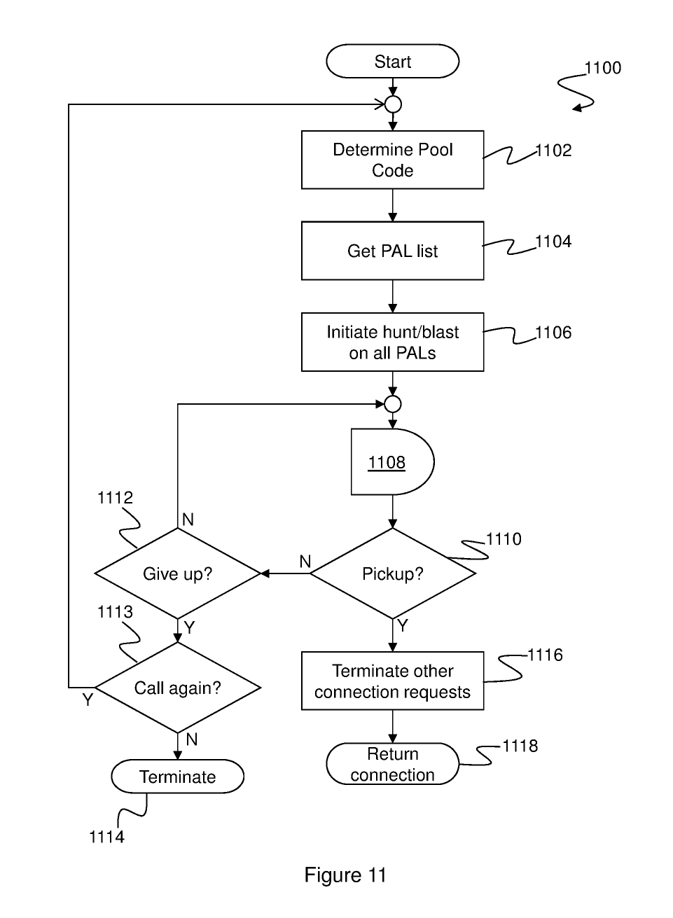

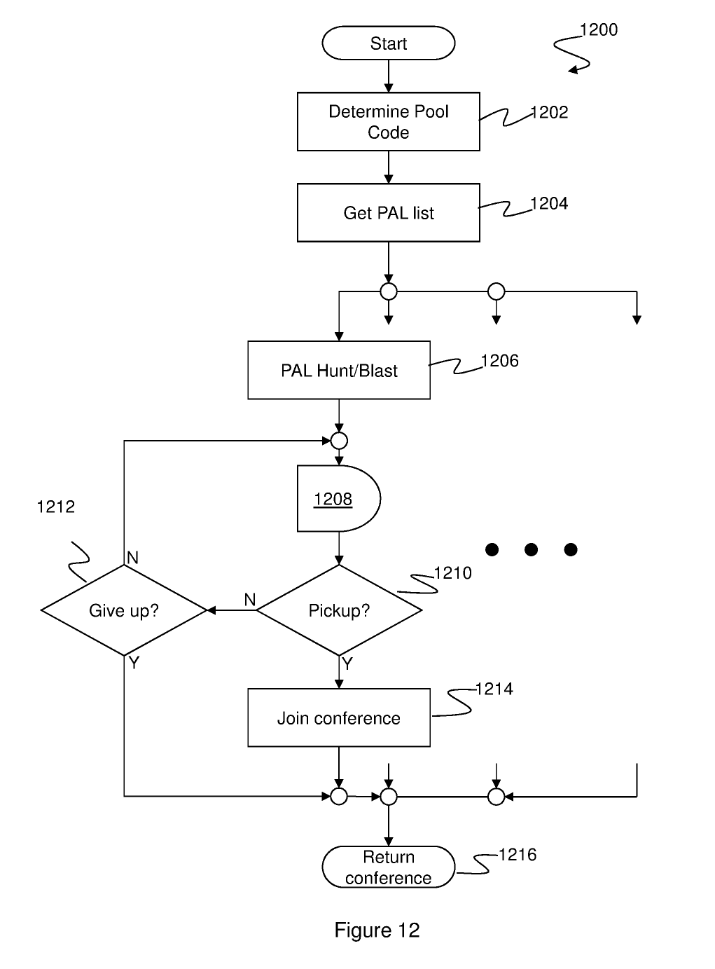

At step 704 the SCP 110 determines whether or not the subscriber command is for a pool operation. In the presently-disclosed embodiment, pool operations and PAL operations may be distinguished simply by the number of dialled digits, i.e. pools are identified by a single digit while PALs are identified by two digits. However, other means of distinguishing between pool and PAL operations, such as the use of dedicated codes or commands, may be employed in alternative embodiments. In the event that a pool operation has been requested, the SCP 110 next determines the calling strategy or policy to be applied. In the event of a hunt policy 706, the SCP attempts a sequential connection 708 to the contacts within the pool (described below with reference to FIG. 10). In the event of a blast policy 710, the SCP 110 makes simultaneous connection attempts 712 to all destinations in the pool, described below with reference to FIG. 11. In the event of a conference connection 714, the SCP 110 attempts to connect with all of the contacts within the pool, and to create a conference bridge 716 (described below with reference to FIG. 12).

If the command did not relate to a pool operation at step 704, control passes to step 718 in which the SCP 110 determines whether or not the command relates to a PAL operation. If so, and if the required strategy or policy is ‘hunt’ 720, the SCP 110 calls each destination in the PAL in sequential priority order, in an attempt to create the desired connection 712. In the case of a blast strategy 724, the SCP 110 makes simultaneous connection attempts 726 to all of the destination numbers/addresses in the PAL. The PAL ‘hunt’ and ‘blast’ operations are described in greater detail below with reference to FIGS. 8 and 9 respectively.

If the subscriber command was neither a pool command nor a PAL command, then at step 728 the SCP 110 attempts to create a connection to a single destination associated with the entered calling code.

FIG. 8 is a flowchart 800 illustrating a PAL hunt operation in greater detail. At step 802, the SCP 110 determines the PAL code contained within the received command. From this code, it is able to determine the corresponding list of destinations from within the associated PAL table (e.g. as shown in Table 1), along with the associated number or identifier, the priority order, and whether or not the destination is currently active. Accordingly, at step 804 the SCP 110 has access to a list of active destinations in priority order.

The SCP 110 then proceeds to call each of the destinations, until all have been exhausted, and/or a response is received and connection created. At step 806 the SCP 110 determines whether all of the destinations in the list have been attempted. If so, and no answer has been received, then the attempt to connect to the corresponding contact fails 808.

However, if there are further destinations in the list, then at step 810 the SCP 110 attempts to call the next destination in the list. If this connection attempt is successful 812, then the overall hunt process succeeds 814, otherwise the next destination in the list is attempted.

FIG. 9 is a flowchart 900 illustrating a PAL blast strategy. At step 902, the SCP 110 determines the PAL code from the command received from the subscriber. As with the PAL hunt 800, this code enables the SCP 110 to identify a group of active destinations from the associated PAL table, at step 904.

At step 906, the SCP makes a simultaneous attempt to call all of the active destinations. The SCP then waits 908 to determine whether one of the connection attempts is successful.

For as long as no connection is established (i.e. there is no answer) 910, the SCP 110 determines whether a suitable time period has elapsed 912. If so, then the connection attempt fails, and the subscriber may be prompted for the opportunity to attempt a further call 913, to the same or a different party. If not, then the process terminates 914.

Otherwise the SCP 110 continues to wait for an answer to one of the simultaneous connection attempts. The timeout 912 may be a predetermined maximum time period, and/or it may be triggered if the calling subscriber ceases waiting for a connection, and disconnects.

If one of the connection attempts is successful, and an answer is received, all of the other connection requests are terminated at step 916. The connection is then established to the answering destination endpoint, and the connection succeeds 918.

Overall, therefore, the PAL blast strategy 900 attempts all of the destination contact's available numbers/addresses simultaneously, and connects only to the first one to pick up.

FIG. 10 is a flowchart 1000 illustrating a pool hunt procedure according to embodiments of the invention. At step 1002 the SCP 110 determines a pool code from the received subscriber command. The pool code is used to look up the corresponding pool (e.g. as shown in Table 2) and to obtain a list of the associated PALs in priority order, at step 1004. The SCP 110 then proceeds to attempt to connect to each of the contacts, corresponding with each successive PAL, in priority order.

Specifically, at step 1006 the SCP 110 checks to see whether all available PALs have been attempted. If so, then the connection attempt fails 1008. Otherwise, an attempt is made at step 1010 to create a connection with the contact corresponding with the next PAL in the list. The PAL connection attempt may follow either a hunt strategy 800, or a blast strategy 900, depending upon the default PAL policy, and/or any specific direction that may be included within the received command. If the connection attempt has succeeded 1012, then a connection is returned at step 1014. Otherwise, the SCP 110 proceeds to the next PAL in the priority list.

FIG. 11 is a flowchart 1100 illustrating a pool blast procedure. At step 1102 the SCP 110 determines a pool code form the received subscriber command. At step 1104 the corresponding PAL list is obtained. At step 1106, the SCP 110 simultaneously initiates a PAL operation for each of the PALs within the pool list. The operation which is initiated is based upon the policy for each PAL, and may be either a PAL hunt procedure 800, or a PAL blast procedure 900. The SCP then waits 1108 to see whether a connection is established 1110 with any one of the destinations within any one of the PALs. In the event of a timeout, or other termination condition 1112, the subscriber may be prompted for the opportunity to attempt a further call 1113, to the same or a different party, of group of parties. If not, then the process terminates 1114. Alternatively, if one of the destinations responds, then all of the other pending connection requests are terminated 1116, and the successful connection is returned 1118.

FIG. 12 is a flowchart 1200 illustrating a pool conference call procedure embodying the invention. At step 1202 the SCP 110 determines a pool code from within the received subscriber command. At step 1204 a corresponding entity list, i.e. a list of PALs and/or destinations, is obtained from the pool table (e.g. such as Table 2).

The SCP then initiates simultaneous connection attempts 1206 to all PALs. The connection attempts 1206 may employ a hunt policy or a blast policy, depending upon a default PAL policy, or upon specific instructions contained within the received subscriber command.

In each case, the SCP waits 1208 to determine whether the connection request is accepted as one of the destinations within the PAL. If the connection is accepted 1210, then at step 1214, the corresponding endpoint is joined to a conference bridge. However, if the connection is not accepted within a suitable time limit, or prior to some other termination condition 1212, then the SCP 110 will cease further attempts to join the associated PAL contact to the conference call.

Once all responding destination endpoints have been joined 1214 to the conference, and/or connection attempts have terminated 1212, the conference connection process ends 1216. The calling subscriber, and all responding destinations, then remain in the conference bridge until the relevant termination conditions occur. For example, the bridge may be terminated when the calling subscriber disconnects, or may be allowed to persist until all parties have disconnected. These, and/or other conferencing options, may be implemented as desired within the SCP 110 configuration, and/or may be selectable by the subscriber when entering initial calling commands.

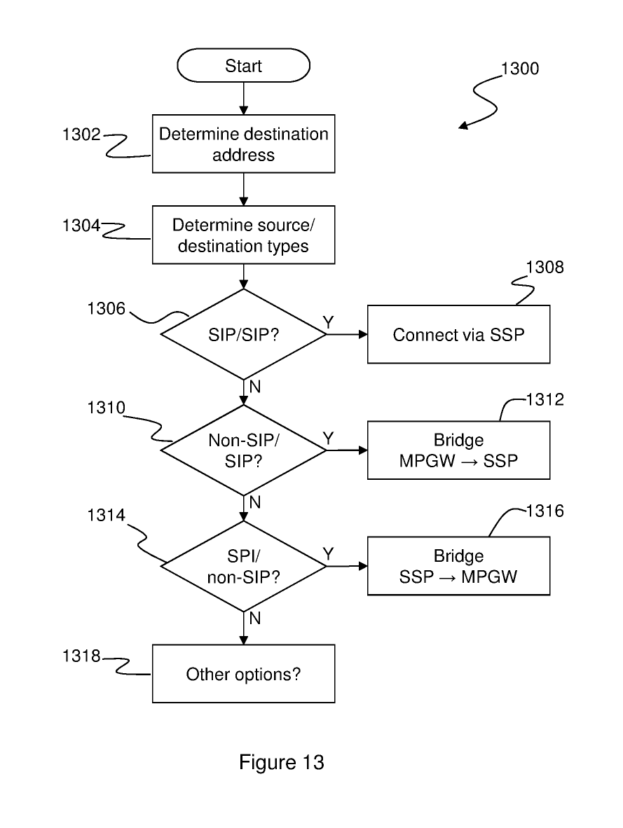

Turning now to FIG. 13, there is shown a flowchart 1300 illustrating the general connection procedure adopted within the multi-protocol communications switching system 100. The connection procedure 1300 is utilised any time a connection attempt is required, for example at step 728 of the process 700, step 810 of the process 800, and/or step 906 of the process 900. In general, the connection process 1300 enables connections to be made between like endpoints (e.g. SIP source to SIP destination), or between dissimilar endpoints (e.g. between a SIP source and a Skype destination).

At step 1302, the SCP 110 determines the required destination number or address. Then, at step 1304 the SCP 110 determines the respective source and destination service types, if this has not already been done. In the presently-disclosed embodiment, handling of the call is unaffected by the source service type identified at this stage, and source-type identification may therefore be omitted. However, in alternative embodiments the source type may be employed for routing, billing, feature selection and/or business decision-making. For example, knowledge of both source and destination types and capabilities may enable more efficient routing or bridging of calls, the implementation of reduced or enhanced feature sets, provision of improved quality-of-service, providing better call control, providing better call progress information and so forth.

In the case of a connection between a SIP source and SIP destination 1306, a connection is established via the SSP at step 1308.

In the case of a connection between a non-SIP source and a SIP destination 1310, the SCP establishes a bridge between the SSP 106 and the MPGW 108 in step 1312, as described above with reference to FIG. 3.

Similarly, in the case of a connection between a SIP source and a non-SIP destination 1314, the SCP 110 establishes a bridge between the SSP 106 and the MPGW 108, in the reverse direction.

Although other options are not configured in the embodiment described herein, it is possible that additional forms of endpoint might be supported, using system elements other than the SSP 106 and the MPGW 108, and/or generalised or enhanced SSP 106 and MPGW 108 implementations. For example, features such as support for video, text messaging, instant messaging/chat, and so forth, may be provided via the SSP 106 and MPGW 108 based upon the same underlying protocols as for voice calls. In some embodiments, SIP may be employed to support video and text through a combination of modules, codecs and protocol extensions. The Skype protocol is similarly self-contained to offer each of these three services, as is the Extensible Messaging and Presence Protocol (XMPP) used by Google Talk, and the extended XMPP protocol Jingle. Such feature/service expansion may therefore be supported in embodiments of the invention without modification to the architecture, or addition of components or protocol support. Additional resources may be allocated to the system 100 to increase capacity and handle higher service volumes, for example in a cloud-based implementation in which additional physical and/or virtual server resources may be allocated and releases according to demand. Accordingly, the process 1300 includes provision 1318 for additional options to be supported, within future embodiments of the invention.

Embodiments of the invention may further provide additional ‘intelligent’ call routing based upon user-defined rules, which may be created and stored in association with a PAL table for a particular contact. An example of the logical structure of an extended PAL table including granular time and location rules is shown in Table 3.

In the extended PAL Table 3, each contact has associated additional intelligent routing rules, which are defined by the subscriber. In the example shown, the extended rule information includes day and time information, and incoming country information. The day and time information specifies the period, over the course of a week, at which the subscriber anticipates that the corresponding contact may be available at the associated destination number or address. Thus, for example, the subscriber may specify that a contact office number should be employed during hunt, blast and conference call connection attempts only on weekdays Monday to Friday, between 8:00 am and 5:00 pm. However, the contact mobile number may be used in call connection attempts on all days Monday to Sunday, at any time.

An incoming country identifier may be used to determine whether or not a number should be called based upon a current location of the calling subscriber. An example given in Table 3 is of taxi service numbers in different locations around the world. The location of the subscriber, for example based upon the incoming country code, may be used to select which of the available taxi service numbers is called, when the subscriber dials the contact code (60#).

TABLE 3

| | Contact | | | | | | | | | Incoming |
|---|---|---|---|---|---|---|---|---|---|---|
| Contact | Tawqk ™ | | | Tawqk ™ | | | | | | Country |
| Name | Code | Destination | Alias | Code | Priority | Active | Policy | Days/Wk | Time | Code |
| Roger | 15# | 61733585660 | Office | 151# | 2 | Y | Hunt | Mon-Fri | 08:00-17:00 | N/A |
| Moore | | 61412347456 | Mobiie | 152# | 3 | N | | Mon-Sun | 00:00-23:59 | N/A |
| | | roger.moore | Skype | 153# | 1 | Y | | Mon-Fri | 08:30-18:30 | N/A |
| | | rm007@gmail.com | Google | 154# | 4 | Y | | Fri-Sun | 00:00-23:59 | N/A |
| | | | Talk | | | | | | | |
| | | | XMPP | | | | | | | |
| Taxi | 60# | 132828 | BNE | 601# | 0 | Y | N/A | Mon-Sun | 00:00-23:59 | 61 |
| | | 18008758200 | NYC | 602# | 0 | Y | N/A | Mon-Sun | 00:00-23:59 | 1 |
| | | 08000856044 | LON | 603# | 0 | Y | N/A | Mon-Sun | 00:00-23:59 | 44 |

In making hunt, blast and conference connections, available destination identifiers (numbers or addresses) are used in priority order, only if they are flagged as active, and additionally if all of the user-defined routing rules are satisfied. This provides the subscriber with a great deal of control over how and when individual contacts are called, and additionally all of the associated contact and routing information is maintained within the multi-protocol communications switching system 100, e.g. in the SDP 112 database. The subscriber's contacts and associated details are therefore available from any communications device throughout the world, and the subscriber is not dependent upon this information being maintained within a particular smart phone or other computing device.

Embodiments of the invention may provide an additional text-based interface to manage and use the various calling, routing and conferencing facilities of the system. A subscriber may submit text-based requests, for example, via a smartphone app using an on-screen keyboard, via a PC or laptop using a standard keyboard, through messaging services (e.g. SMS or Skype messaging), via touch-tone dialling (e.g. using a standard mapping of numbers to letter groups), and/or by any other convenient means. A text-based request may comprise a text string using, for example, an asterisk (‘*’) as a delimiter and a hash or pound sign (‘#’) as a terminator, however other message formats and syntax may alternatively be employed.

Subscribers may be provided with a facility to map contacts and/or collections of contacts, and their associated codes (e.g. PAL and pool codes) to text strings that are more easily memorable for human users. For example, the subscriber may map the PAL code ‘15#’, as shown in Table 1, to the text string ‘ROGE’ (or any other meaningful string having a system-defined maximum and minimum length, e.g. of between four and eight characters). Such mapping may be stored in a translation table associated with the subscriber's account, such that when the text string ‘ROGE#’ is entered, the system can look up the corresponding PAL code (‘15#’) and take the same actions as if this code had been entered directly.

Additional functionality may be provided via a text-based interface. For example, command or instruction codes may be supported to enable greater control of calling behaviour. In one exemplary implementation instruction codes ‘MOB’, ‘OFF’, ‘SKY’ and so forth are provided to enable the subscriber to specify a destination device, i.e. mobile, office, Skype etc. Thus a command such as ‘ROGE*MOB#’ is translated by the system by looking up the PAL table corresponding with code ‘15#’ (from translation of ‘ROGE’), and selecting calling code ‘152#’ in order to call the corresponding mobile number directly. A limited hunt or blast operation (depending on the default policy in the PAL) may be requested by using a string such as ‘ROGE*MOB*OFF#’, which instructs the system to try the mobile number first, and then the office number. An explicit hunt, blast or conference call may be requested, overriding the PAL policy if required, by a command such as ‘ROGE*MOB*OFF*HT#’, ‘ROGE*MOB*OFF*BT#’ or “ROGE*MOB*OFF*CF#” respectively.

Embodiments of the text-based interface may provide still further functionality, features and options. For example, omitting a section of a command may imply using all of the matching numbers, as in ‘ROGE**BT#’, which requests the system to blast all of the available numbers for the contact, overriding the default ‘hunt’ policy. The system may further permit the use of a specified phone number anywhere in a command that a device code may be used. It may provide instructions controlling dialling, such as a command CPU′ to insert a pause so that, for example, ‘<Hotel Number>**PU*<Room Number>#’ may be used to call a hotel, pause to allow an auto-attendant call router to pick up, and then dial the room extension number.

Additionally, contacts may be concatenated so that, for example, the command string ‘ROGE*MOB**SEAN*SKY**CF#’ would request a conference call connecting the caller codes ‘152#’ and ‘103#’ (see Table 2).

In some embodiments, the text command interface may also be configured to enable subscribers to update or modify the PAL and pool tables. For example, a command string such as ‘1**PL**ROGE*MOB*SKY**SEAN*MOB*SKY**CF**SV#’ creates a new pool entry for ‘1#’ for a conference call between the two contacts shown in Table 2. The command string is interpreted as follows: ‘1’ is the Pool Id; ‘**PL’ instructs the system to create, edit or delete the pool (as required based on the current contents of the pool table and the remainder of the command); add the specified contacts and devices to the pool; assign a policy or call type of conference (′CF); and then save the new pool definition (‘SV’). This call can subsequently be accessed simply by dialling the pool code ‘1#’.

The above description of text-based commands is provided by way of example only. It will be appreciated that alternative and/or additional command strings, formats and functions may be implemented employing the same general principles. Indeed, all available functionality of the system may be made accessible through a suitable definition of command strings and syntax, and the above examples should not be considered limiting.

A further feature of embodiments of the invention is call initiation and scheduling via messaging services and/or a web interface. Specifically, subscribers may send SMS or instant messages to a number or address associated with the multi-protocol communications switching system 100. The messages will be received at the SCP 110. The SCP 110 then interprets the content of the message, and takes the appropriate actions to initiate a call. For example, a message may identify a subscriber, a current subscriber endpoint number or address, and a corresponding destination contact name, contact PAL code, destination code, or destination endpoint number or address. The SCP 110 then attempts to make a connection to the appropriate destination endpoint (using any of the relevant connection methods as described above), and if the connection attempt is successful then creating a connection back to the calling subscriber. In the case of SMS messaging, the calling subscriber may not be required to provide an associated number, in which case the SCP 110 may use the number from which the SMS message originates.

Alternatively, the subscriber may be enabled to log into a web-based interface, for example via the web server 118, and request the placement of a call to a specified contact, pool, or destination number/address.

The multi-protocol communications switching system 100 may support a variety of different interfaces and messaging accounts, including Google Talk, Skype, Facebook, Windows Live, Yahoo, AOL Messenger, and so forth.

Further extended messaging syntax may also enable the subscriber to specify a particular date and time at which the nominated call should be placed. This enables the system to be used for scheduling of future calls, thus saving the subscriber from having to maintain a separate diarying/reminder system for teleconferencing appointments.

Furthermore, initiation of calls via SMS, instant messaging and/or the World Wide Web enables the subscriber to initiate a call without incurring outbound calling charges on the local network. This may be particularly advantageous, for example, in locations where a local number for contacting the multi-protocol communications switching system 100 is not available, and/or where time-based charging is applied to outgoing local calls.

Embodiments of the invention may provide a variety of different mechanisms by which new subscribers may sign up and register for access to the service. According to one arrangement, new subscribers may sign up via a web-based interface, e.g. through accessing the web server 118 from a conventional web browser. A simple web signup process requires the new subscriber to provide only an email address, a corresponding name, password, home country, and at least one registered number. This information may be stored in the SDP 112 database, and subsequently any calls received by the SCP 110 from any one of the subscriber's registered numbers will be automatically associated with the subscriber account. Each subscriber may be permitted to register a predetermined maximum number of originating numbers or addresses, for example five numbers or addresses, 10 numbers or addresses, or any other desired quantity for which the system 100 is configured.

An operator of the system 100 may also provide various promotional means for encouraging signup. For example, a clickable web-based advertisement or button may be embedded within other web pages, whereby clicking on the associated web page element takes the user to the subscriber registration page. The clickable button or image may be associated with a link which identifies an affiliate partner hosting the promotional element, enabling affiliates to be paid for referrals of new subscribers who register with the service provided by the system 100.

Other means of registering and accessing the services of the multi-protocol communications switching system 100 include the provision of a dedicated desktop application, a browser plug-in, a browser toolbar, a smart phone app, or the like, providing a convenient user interface to the functions available from the system 100. Back-end communications between such apps and plug-ins may be via instant messaging protocols, as described above, or by equivalent proprietary messaging methods.

In embodiments of the invention, each subscriber account has an associated PIN. The PIN should be long enough to ensure that each subscriber has a unique number, and to make brute force hacking attempts impractical. The subscriber does not require the PIN when calling from a registered number or address, however when calling from an unrecognised number or address (step 608 in FIG. 6) the PIN may be provided in order to identify the subscriber.

The PIN may also be required if the subscriber wishes to perform administrative functions on their account via a telephony handset. Administrative features include adding, changing or removing contacts, PALs, pools, and so forth. Administrative features also include financial operations, such as checking a subscriber account funds balance, adding funds to the account, enabling and disabling auto-charging features, modifying payment details (e.g. credit card number), and so forth. The PIN would also be required for operations such as changing a registered email address, changing a password, or changing the PIN itself.

Embodiments of the invention support prepaid calling services. Typically, a subscriber is required to transfer funds into their service account before chargeable calls may be made. Funds may be transferred, for example, via the web interface 118. Funds may also be transferred via other means, such as direct debit, electronic transfer from an Internet banking service, or by credit card payment. Embodiments of the invention permit a subscriber to associate a payment account, such as a credit card account, with their service account within the system 100. Once this is done, the subscriber will no longer be required to enter full payment details each time funds are to be added to their account. Furthermore, embodiments may provide an auto-payment feature, according to which additional account funds are automatically transferred, e.g. from a registered credit card, when the available funds become low. Subscribers may add funds to their account, and activate or deactivate an auto-payment system, via the web interface 118, and/or via instant messaging or through a touchtone or AVR menu system from a conventional telephony handset.

The web interface 118 may also provide ongoing real-time access to subscriber account activity. By logging in to the server 118 from a conventional web browser, the subscriber may be provided with web access to account information, such as a log of calls made, services used, and funds expended. Additionally, real-time information regarding any calls currently in progress may also be provided. The web server 118 is able to access all of this information on an ongoing basis from the SCP 110, the SDP 112 database, and the B/OSS 116.

The foregoing discussion describes a number of basic and additional features provided by embodiments of the invention. However, it will be appreciated by persons skilled in the art of telecommunications, and of computer systems design and programming, that the multi-protocol communications switching system 100 generally provides a highly flexible platform, via which a range of innovative services may be designed and implemented through appropriate configuration and programming of the microprocessor-based elements of the system 100. A number of further features that may be provided by embodiments of the invention will therefore now be outlined, by way of example. However, these features and services are by no means an exhaustive listing of the potential facilities provided by a multi-protocol communications switching system embodying the invention.

Additional services may, for example, allow users to temporarily override the calling policies (e.g. hunt or blast) defined within a PAL or pool table. Simply preceding the PAL or pool code with an appropriate override code, as part of the command provided by the SCP 110 when requesting call connection, enables the subscriber to specify a calling policy to be used for that call only.

Yet another feature of embodiments of the invention is the ability to switch between registered devices in the course of a call. For example, a subscriber may have a mobile/cellular number registered with their account, along with a fixed-line number, such as a home or office phone. A call may be initiated from the mobile/cellular number, when the user is out of the office. Upon returning to the office, if the call is still in progress the subscriber may dial a specified touchtone command which will be detected and interpreted by the SCP 110. In one embodiment of this feature, the SCP 110 then simultaneously sends connection requests to all of the subscriber's other registered numbers, including the office fixed-line phone. When the subscriber picks up one of the called numbers, the other connection requests are terminated, and the connection with the mobile/cellular handset is also terminated. The subscriber then continues the call using the office handset.

Further functions for the transfer of one or more endpoints of an established call may also be implemented in embodiments of the invention. For example, in a scenario in which a subscriber has established a call with a remote party, the subscriber may subsequently initiate a transfer of the remote end of the call from a first communications device to a second communications device of the remote party. The second device may be identified in a similar manner to the subscriber transfer described above, i.e. the subscriber may provide an identifying number, a PAL code or a pool code, and the SCP 110 may then send connection requests to the associated devices. When the remote party picks up one of the called devices (i.e. the second device), all outstanding connection requests are terminated, and the SCP 110 can terminate the existing connection with the first device and reconnect to the second device, in order to effect the transfer.

In some embodiments, the subscriber may also be able to initiate a process enabling the remote party to identify the second device. For example, a specific code, such as a touchtone command, may be entered by the subscriber, which will cause the SCP 110 to play a voice prompt requesting the remote party to enter a number associated with the second device. The number can then be entered by the remote party using a touchtone keypad, decoded by the SCP 110, and used to send a connection request to the identified second device. When the remote party picks up the second device, all outstanding connection requests are terminated, and the SCP 110 can terminate the existing connection with the first device and reconnect to the second device, in order to effect the transfer.

Furthermore, in some embodiments a non-subscriber party to an established call may be able to initiate a transfer. For example, a non-subscriber may enter a specific feature code via their handset or other device, which provides access to a predetermined set of non-subscriber features including (though not necessarily limited to) a call transfer feature. The non-subscriber would then enter any further information necessary for a selected feature. In the case of a call transfer, these would include identifying details—such as a telephone number—of the second device to which the call is to be transferred.

While a telephone number is the most practical identifier for the second device in the case of a transfer, particularly if the first device is a basic handset with only a touchtone keypad for input, other identifiers may also be supported. For example, if supported by the first device (e.g. via a keyboard, touchscreen, or other input device), a Skype or Google Talk identifier may be entered using a simple syntax such as ‘skype_<ID>’ or ‘gtalk_<ID>’.

A further service which may be provided by embodiments of the invention is the ability for a non-subscriber to access the multi-protocol communications switching system 100. A user who is not registered as a subscriber may nonetheless contact the SCP 110 using the relevant local number. As a non-subscriber, the user will be required to provide payment details for the purposes of the desired call. In some embodiments, the user may be permitted to make any length of call desired, and will be charged for the time used once the call completes. In other embodiments, the user may be limited to a fixed maximum call duration or value. These and other service options may be configured by suitable programming of the SCP 110.

In a further variation, the unregistered user may be able to create a new subscriber account, with basic details, directly from a calling device upon their first use of the system. By providing basic identification and payment information, a minimal account may be created for the user in which only the initial calling device is registered. Added security may be provided in this service by limiting the user to sign up via particular ‘trustworthy’ device types, such as mobile/cellular phone.

This enables two forms of additional security. Firstly, most countries now have regulations in relation to the sale and issue of cellular mobile phones and numbers. This limits the ability for fraudulent use. Additionally, mobile/cellular handsets are almost universally SMS-capable, which enables verification to be performed via SMS messaging, in order to prevent calling number ID spoofing. The new subscriber may subsequently add information, such as additional registered numbers and addresses, to their account via the web interface 118, or other available means.

In embodiments of the invention, a device-based signup as described above may be initiated by sending an SMS message. By sending a message to a specified service number, the system 100, via the SCP 110, is able to call the user back via the source number associated with the SMS message. The call-back may be preceded by a further verification SMS message. Once a connection between the SCP 110 and the subscriber device has been established, the signup process proceeds as described above.

The TTS and ASR capabilities of the media server 114 may be used to provide functions such as voice searching and voice-based control of other services provided by the system 100. For example, after creating a connection to the SCP 110, a subscriber may be able to search their contacts, PALs and pools, via voice commands. The subscriber may also be able to call a specified number of addresses simply by speaking the desired destination identifier. Contact directory information, and requests for further details required to identify a desired destination contact, calling policy, and so forth, may be provided by audio to the subscriber, using the TTS capabilities of the media server 114.

With regard to charging for services, it is known for telecommunications service providers to offer discount rates amongst subscribers to their services. In particular, subscribers to a service provider network may be charged at a constant discount rate for calls to subscribers on the same network. In some instances, such calls may be free. However, this charging model is not feasible in prior art systems where subscribers are connected via networks operated by different service providers, since each service provider charges other providers for interchange/access to its network. These real costs of interconnection must be passed on to the subscriber.

Embodiments of the present invention, however, enable the implementation of novel charging models. Subscribers are able to access the services provided independently of the actual originating and destination networks, protocols and/or service providers. The costs of interconnection are significantly reduced, because long-distance transport is substantially conducted via the internet 502. It is therefore feasible to offer discounts (as opposed to fixed rates) for calls between subscribers, for example as a percentage reduction on the normal rates charged which will, in turn, typically be based upon the actual interconnection costs along with additional charges to cover the costs of providing the services to the subscriber. A reduction in these additional charges to provide discount calling between subscribers reduces the profit margin, but also provides an incentive for subscribers to encourage their contacts, friends, families, co-workers, associates and so forth to subscribe to the same service.

Embodiments of the invention may also be configured to provide subscribers with a global telephone number (iNum). An iNum is a unique identifier formatted according to the E.164 standard, which is associated globally with a particular individual. Access to call an iNum is currently available in around 50 countries. The holder of an iNum obtains the number free, but must pay to have the call forwarded from its origin to their current location, with which the iNum is associated. In general, this means that an iNum holder may be required to pay unpredictable, and potentially high, international calling charges depending upon the location of the caller.

However, provision of an iNum service via the multi-protocol communications switching system 100 enables a subscriber to control the cost associated with iNum ownership. The originating call based on an iNum is directed to a local endpoint in the country of origin, and then routed through to the SCP 110 via the Internet, in the manner shown in FIG. 5. The costs associated with this call are those of a local call in the originating country and the normal discounted call rates associated with the service provided by the multi-protocol communications switching system 100, which are borne by the service subscriber (i.e. receiving party in this instance). Notably, the local call costs are borne by the calling party, which in many cases will be included in the caller's network subscription/plan and thus effectively free, and may be unlimited in terms of number of calls and length of each call). Alternatively, the calling party may use another service (such as Google Talk or another VoIP service capable of making calls to iNums) in order to initiate a call to the iNum directly over the Internet, thus reducing the cost of the call further by eliminating the costs at the calling party end while adding flexibility and greater access to the user via their iNum. Whereas PSTN access to an iNum is currently available only in a limited number of countries, a VoIP call using services such as Google Talk can be made in any country in the world.

Embodiments of the invention may also support direct SIP client connectivity. That is, the SSP 106 and SCP 110 may be configured to receive SIP-based connections from generic VoIP client software executing on a computer, a smart phone, or any other suitable hardware/software device. While this service requires additional technical sophistication from the subscriber, in order to properly configure and maintain a SIP client, it also provides additional flexibility, enabling calls to be made from any suitable Internet-connected device, regardless of local availability of VoIP services. Advantageously, an operator of the system 100 may provide a dedicated application, e.g. a smartphone app, to subscribers which is self-configuring once the subscriber has signed into their account, to enable the subscriber subsequently to initiate and receive VoIP calls without further manual configuration.

In yet a further variation, a web-based service may be provided enabling subscribers to create SIP connections via a web service. A browser plug-in, applet or the like may be provided by a web server, e.g. server 118, providing the bidirectional voice interface, while the SIP call itself originates with the web client supported by a server on the provider side to handle these requests. The user therefore does not own or operate the SIP client directly, which is centrally maintained by the service provider on a web server. Calls may thus be made by any user with access to a suitable web browser, and the Internet.

In yet another embodiment, a further variation/enhancement of the above is implemented by further adapting the software comprising the MPGW component. In particular, the multi-protocol system 100 may be configured to support additional web-based communications technologies (e.g. the WebRTC real-time communication framework) which allow single and multi-party multimedia sessions to take place using only an updated version of the web-browser software, without the need for any additional browser or platform specific plugin, extension or applet to be installed. Multimedia sessions may comprise voice, video and data i.e. instant messaging, file transfer, screen/whiteboard sharing and collaboration.

These web-based technologies are currently being adopted as standard built-in features of major/popular web-browsers. Concurrently, an increasingly wide array of consumer devices, multimedia consoles, appliances and user-panels are now being made “smart” i.e. are internet-connected and come equipped with web-browsers (at the very least).

A subscriber of the service will thus be able to initiate and/or participate in single or multi-party conversations simply by logging into their user account from the built-in web-browser on any suitably-configured smart device, panel, console or interface, and communicate with his or her contacts, independent of their own location or device, without having to pre-register either a caller-ID or user-ID for identification purposes, or install a device-specific app or add-on for that specific platform. This will advantageously further enhance and increase ways, modes and ease by which a subscriber is able to access and communicate through a system embodying the invention.

In one exemplary scenario, a subscriber of the service might log into their account from a web-browser equipped, internet-connected smart command console of any vehicle to participate in a multi-party conference over the vehicle's audio system, without requiring additional hardware, firmware or software, without previously registering the identity of the vehicle's console with the multi-protocol system 100 and without having to themselves undergo any further identity verification.

Various details, features, functions, facilities, capabilities and service options of embodiments of the present invention have been described above. As will be appreciated by the skilled person, however, these are not intended to be exhaustive. A significant benefit of embodiments of the present invention is the provision of a highly flexible and configurable platform, in the form of a multi-protocol communications switching system 100 which may be reconfigured via programming and/or the addition of further hardware components, in order to provide a wide variety of Internet-based telephony services.

Embodiments of the invention thus provide a system comprising a globally distributed, universally accessible multi-protocol hosted platform, which may be used, for example, by a single user, group of users, a team, family or a small business. The system effectively enables subscribers to create an ad hoc micro PBX/phone system in the cloud, by arranging and organizing multiple contacts, multiple destinations per contact (PALs) and multiple contacts per pool/group. The nested groupings (i.e. PALs, pools) provided in embodiments of the invention provide high levels of convenience, and an integrated multi-protocol framework for reachability of contacts, to create a comprehensive calling service with improved capabilities as compared with prior art services.

In essence, services based upon embodiments of the invention enable subscribers to create their very own phone systems where everyone they care to call is merely an extension on that system regardless of their location, device, service, network or affiliation.

The scope of the invention is therefore not limited to any of the embodiments described or outlined above, but is defined by the scope of the claims appended hereto.

1. A multi-protocol communications switching system comprising:
a service switching point (SSP) interfaced with an Internet Protocol (IP) network, and configured to accept, switch and initiate Voice over IP (VoIP) telephony calls;
a multi-protocol gateway apparatus (MPGW) interfaced with the IP network, and configured to accept, switch and initiate communications sessions based upon one or more of a plurality of configured protocols, and to convert communications session data and signalling messages between the configured protocols; and
a service control point (SCP) interfaced with the SSP and the MPGW, and configured to accept and initiate VoIP telephony calls via the SSP, to accept and initiate communications sessions via the MPGW, and to bridge VoIP telephone call data and communications session data between the SSP and the MPGW.

2. The system of claim 1 wherein signalling across the interface between the SSP and SCP and across the interface between the MPGW and the SCP, is based upon a common signalling protocol.

3. The system of claim 2 wherein the common signalling protocol is Session Initiation Protocol (SIP).

4. The system of claim 3 wherein the plurality of configured protocols of the MPGW includes a VoIP telephony protocol comprising SIP signalling, and one or more alternative voice communications protocols,
wherein the SSP, SCP and MPGW are configured to establish a first VoIP telephony session between the SSP and the SCP and to establish a second VoIP telephony session between the MPGW and the SCP,
wherein the MPGW is configured to convert communications session data between the alternative voice communications protocols and the VoIP telephony protocol, and
wherein the SCP is configured to bridge the first VoIP telephony session and the second VoIP telephony session.

5. The system of claim 4 wherein the alternative voice communications protocols comprise one or more of a Skype protocol and an Extensible Messaging and Presence Protocol (XMPP).

6. The system of claim 4 wherein the SCP is configured to instantiate a back-to-back user agent (B2BUA) entity which is adapted to terminate and bridge the first and second VoIP telephony sessions.

7. The system of claim 2 wherein the plurality of configured protocols of the MPGW includes first and second distinct communications protocols,
wherein the SCP and MPGW are configured to establish a first communications session between the MPGW and the SCP corresponding with the first communications protocol, and to establish a second communications session between the MPGW and the SCP corresponding with the second communications protocol, wherein the first and second communications sessions use the common signalling protocol,
wherein the MPGW is configured to convert communications session data between the alternative voice communications protocols and the VoIP telephony protocol, and
wherein the SCP is configured to bridge the first VoIP telephony session and the second VoIP telephony session.

8. The system of claim 1 further comprising a Service Data Point (SDP) interfaced with the SCP, the SDP comprising a database containing at least subscriber information and service information.

9. The system of claim 1 further comprising a Billing/Operational Support System (B/OSS) which is interfaced with the SCP and configured to provide call processing and control services to the SCP.

10. The system of claim 9 wherein the call processing and control services for which the B/OSS is configured comprise one or more of: instructing the SCP to prompt for user input; instructing the SCP to capture user input; determining connection parameters; and instructing the SCP to establish a connection.

11. The system of claim 9 wherein the B/OSS is further configured to log connection information and to update subscriber billing information.

12. The system of claim 1 further comprising at least one media server which is interfaced with the SCP and configured to perform one or more media support functions.

13. The system of claim 12 wherein the media support functions for which the media server is configured comprise one or more speech functions.

14. The system of claim 9 further comprising at least one web server interfaced to the B/OSS and accessible via the internet, wherein the web server is configured to provide access to customer information maintained by the B/OSS via a web-based interface.

15. The system of claim 14 wherein the web server is configured to provide network operator access to perform supervisory and management functions.

16. The system of claim 14 wherein the web server is configured to provide customer access to provide service and billing functions, wherein the service and billing functions comprise one or more of: reviewing call history; creating, modifying and viewing customer account configuration, settings and preferences; updating customer account configuration, settings and preferences; viewing customer billing information; and making payments.

17. The system of claim 1 wherein the plurality of configured protocols of the MPGW includes one or more alternative multimedia communications protocols capable of supporting digital voice, video and synchronous and asynchronous structured data/message transfer.

18. The system of claim 17 wherein the one or more alternative multimedia communications protocols comprises a WebRTC framework.

19. A method of multi-protocol communications switching comprising:
receiving, via an internet protocol (IP) network, an incoming call request initiated from a call originating endpoint and formatted in accordance with a first one of a plurality of predetermined protocols, wherein the predetermined protocols include a Voice over IP (VoIP) telephony protocol;
establishing a first telecommunications channel with the call originating endpoint;
receiving, from the call originating endpoint, information identifying at least one call destination endpoint associated with one or more of the plurality of predetermined protocols;
initiating, via the IP network, an outgoing call request directed to the call destination endpoint and formatted in accordance with a second one of the plurality of predetermined protocols;
establishing a second telecommunications channel with the call destination endpoint; and
bridging the first and second telecommunications channels to establish a connection between the call originating endpoint and the call destination endpoint.

20. The method of claim 19 wherein the first and second ones of the plurality of predetermined protocols are dissimilar, and the method further comprises translating communications session data transported via the connection between the call originating endpoint and the call destination endpoint between the first and second ones of the plurality of predetermined protocols.

21. The method of claim 19 wherein the plurality of predetermined protocols further comprises one or more of a Skype protocol and an Extensible Messaging and Presence Protocol (XMPP).

22. The method of claim 19 wherein the information received from the call originating endpoint identifies a plurality of call destination endpoints.

23. The method of claim 22 wherein:
initiating an outgoing call request comprises sequentially initiating an outgoing call request to each one of the plurality of call destination endpoints; and
establishing a second telecommunications channel with a first call destination endpoint to accept a respective outgoing call request.

24. The method of claim 22 wherein:
initiating an outgoing call request comprises simultaneously initiating an outgoing call request to each one of the plurality of call destination endpoints; and
establishing a second telecommunications channel with a first call destination endpoint to accept a respective outgoing call request.

25. The method of claim 22 wherein:
initiating an outgoing call request comprises simultaneously initiating an outgoing call request to each one of the plurality of call destination endpoints; and
establishing at least a second telecommunications channel with a first call destination endpoint to accept a respective outgoing call request.

26. The method of claim 25 further comprising:
establishing at least a third telecommunications channel with a second call destination endpoint to accept a respective outgoing call request; and
bridging the third telecommunications channel with the first and second telecommunications channels to establish a conference connection between the call originating endpoint, the first call destination endpoint and the second call destination endpoint.

27. The method of claim 22 wherein the information identifying at least one call destination endpoint comprises an identifier of a corresponding set of predefined calling rules stored in a database, wherein the method comprises retrieving the predefined calling rules from the database, and initiating an outgoing call request comprises initiating one or more outgoing call requests to one or more corresponding call destination endpoint in accordance with the predefined calling rules.

28. A system for caller-initiated telecommunications connection processing comprising:
a service control point (SCP) interfaced directly or indirectly with an Internet Protocol (IP) network and configured to accept and initiate telecommunications connections via the IP network; and
a database accessible via the SCP and containing calling rules associated with one or more subscribers,
wherein the SCP is further configured to:
receive an incoming call request from a call originating endpoint;
establish a first telecommunications channel with the call originating endpoint;
identify a subscriber associated with the incoming call request;
receive, from the subscriber, information identifying one or more associated calling rules;
retrieve, from the database, the one or more associated calling rules;
establish at least a second telecommunications channel with a first call destination endpoint in accordance with the one or more associated calling rules; and
bridge the first and second telecommunications channels to establish a connection between the call originating endpoint and the first call destination endpoint.

29. The system of claim 28 wherein the calling rules contained within the database comprise one or more access list data structures, each access list data structure being associated with a subscriber and an identifying code, and including a collection of one or more destination endpoint identifiers, whereby:
the information identifying the one or more associated calling rules comprises a corresponding received code identifying a subscriber access list data structure; and
the SCP is configured to establish the second telecommunications channel by identifying and initiating an outgoing call request with the first call destination endpoint using a destination endpoint identifier selected from the collection associated with the subscriber access list data structure in accordance with an access list calling policy.

30. The system of claim 29 wherein the access list calling policy is a hunt policy, whereby the SCP is configured to establish the second telecommunications channel by:
sequentially initiating an outgoing call request to each one of the call destination endpoints identified in the collection associated with the received code; and
establishing a second telecommunications channel with a first call destination endpoint to accept a respective outgoing call request.

31. The system of claim 29 wherein the access list calling policy is a blast policy, whereby the SCP is configured to establish the second telecommunications channel by:
simultaneously initiating an outgoing call request to each one of the call destination endpoints identified in the collection associated with the received code; and
establishing a second telecommunications channel with a first call destination endpoint to accept a respective outgoing call request.

32. The system of claim 29 wherein the calling rules contained within the database comprise one or more pool list data structures, each pool list data structure being associated with a subscriber and an identifying code, and including a collection of one or more entries each of which comprises a destination endpoint identifier or an access list data structure identifier, whereby:
the information identifying the one or more associated calling rules comprises a corresponding received code identifying a subscriber pool list data structure; and
the SCP is configured to establish the second telecommunications channel by identifying and initiating an outgoing call request with the first call destination endpoint using a destination endpoint identifier selected via the collection of entries associated with the subscriber pool list data structure in accordance with a pool list calling policy.

33. The system of claim 32 wherein the pool list calling policy is a hunt policy, whereby the SCP is configured to establish the second telecommunications channel by:
sequentially initiating one or more outgoing call requests according to each one of the entries included in the collection associated with the received code, wherein call requests according to access list entries are initiated in accordance with a corresponding access list policy; and
establishing at least a second telecommunications channel with a first call destination endpoint to accept a respective outgoing call request.

34. The system of claim 32 wherein the pool list calling policy is a blast policy, whereby the SCP is configured to establish the second telecommunications channel by:
simultaneously initiating one or more outgoing call requests according to each one of the entries included in the collection associated with the received code, wherein call requests according to access list entries are initiated in accordance with a corresponding access list policy; and
establishing at least a second telecommunications channel with a first call destination endpoint to accept a respective outgoing call request.

35. A method of caller-initiated telecommunications connection processing comprising:
receiving an incoming call request from a call originating endpoint;
establishing a first telecommunications channel with the call originating endpoint;
identifying a subscriber associated with the incoming call request;
receiving, from the subscriber, information identifying one or more associated calling rules held within a database;
retrieving, from the database, the one or more associated calling rules;
establishing at least a second telecommunications channel with a first call destination endpoint in accordance with the one or more associated calling rules; and
bridging the first and second telecommunications channels to establish a connection between the call originating endpoint and the first call destination endpoint.

36. The method of claim 35 wherein the calling rules contained within the database comprise one or more access list data structures, each access list data structure being associated with a subscriber and an identifying code, and including a collection of one or more destination endpoint identifiers, wherein the information identifying the one or more associated calling rules comprises a corresponding received code identifying a subscriber access list data structure, and wherein establishing the second telecommunications channel by identifying and initiating an outgoing call request with the first call destination endpoint comprises using a destination endpoint identifier selected from the collection associated with the subscriber access list data structure in accordance with an access list calling policy.

37. The method of claim 36 wherein the access list calling policy is a hunt policy, and establishing the second telecommunications channel comprises:
sequentially initiating an outgoing call request to each one of the call destination endpoints identified in the collection associated with the received code; and
establishing a second telecommunications channel with a first call destination endpoint to accept a respective outgoing call request.

38. The method of claim 35 wherein the access list calling policy is a blast policy, and establishing the second telecommunications channel comprises:
simultaneously initiating an outgoing call request to each one of the call destination endpoints identified in the collection associated with the received code; and
establishing a second telecommunications channel with a first call destination endpoint to accept a respective outgoing call request.

39. The method of claim 35 wherein the calling rules contained within the database comprise one or more pool list data structures, each pool list data structure being associated with a subscriber and an identifying code, and including a collection of one or more entries each of which comprises a destination endpoint identifier or an access list data structure identifier, wherein the information identifying the one or more associated calling rules comprises a corresponding received code identifying a subscriber pool list data structure, and establishing the second telecommunications channel comprises identifying and initiating an outgoing call request with the first call destination endpoint using a destination endpoint identifier selected via the collection of entries associated with the subscriber pool list data structure in accordance with a pool list calling policy.

40. The method of claim 39 wherein the pool list calling policy is a hunt policy, whereby establishing the second telecommunications channel comprises:
sequentially initiating one or more outgoing call requests according to each one of the entries included in the collection associated with the received code, wherein call requests according to access list entries are initiated in accordance with a corresponding access list policy; and
establishing at least a second telecommunications channel with a first call destination endpoint to accept a respective outgoing call request.

41. The method of claim 39 wherein the pool list calling policy is a blast policy, whereby establishing the second telecommunications channel comprises:
simultaneously initiating one or more outgoing call requests according to each one of the entries included in the collection associated with the received code, wherein call requests according to access list entries are initiated in accordance with a corresponding access list policy; and
establishing at least a second telecommunications channel with a first call destination endpoint to accept a respective outgoing call request.

42. A system for caller-initiated conference calling comprising:
a service control point (SCP) interfaced directly or indirectly with an Internet Protocol (IP) network and configured to accept and initiate telecommunications connections via the IP network; and
a database accessible via the SCP and containing calling group information associated with one or more subscribers,
wherein the SCP is further configured to:
receive an incoming call request from a call originating endpoint;
establish a first telecommunications channel with the call originating endpoint;
identify a subscriber associated with the incoming call request;
receive, from the subscriber, information identifying an associated calling group;
retrieve, from the database, the associated calling group information;
establish a plurality of conference telecommunications channels each having a call destination endpoint identified in the associated calling group information; and
bridge the first telecommunications channel with the plurality of conference telecommunications channels to establish a conference connection comprising the first telecommunications channel and the plurality of conference telecommunications channels.

43. A method of caller-initiated conference calling comprising:
receiving an incoming call request from a call originating endpoint;
establishing a first telecommunications channel with the call originating endpoint;
identifying a subscriber associated with the incoming call request;
receiving, from the subscriber, information identifying an associated calling group, wherein calling group information associated with the subscriber is held within a database;
retrieving, from the database, the associated calling group information;
establishing a plurality of conference telecommunications channels each having a call destination endpoint identified in the associated calling group information; and
bridging the first telecommunications channel with the plurality of conference telecommunications channels to establish a conference connection comprising the first telecommunications channel and the plurality of conference telecommunications channels.

44. A method in a service control point (SCP) of transferring an endpoint of an established call between two or more parties, at least one of which is a subscriber to a service provided by the SCP, from a first communications device to a second communications device of a transferring party, the method comprising:
the SCP receiving, from the subscriber, a request to transfer the call from the first device;
the SCP receiving, from the subscriber or the transferring party, identifying information of at least one candidate communications device;
the SCP initiating one or more outgoing call requests to the at least one candidate communications device;
the SCP receiving an acceptance of one of the outgoing call requests from a second communications device selected from the at least one candidate of communications device; and
associating the telecommunications channel with the second communications device, and disassociating the telecommunications channel with the first communications device, in order to transfer the call.

45. The method of claim 44 wherein the identifying information of the at least one candidate communications device comprises one or more of: a telephone number; a Skype identifier; or a Google Talk identifier.

46. The method of claim 44 further comprising:
the SCP maintaining a subscriber database containing records of identifying information of a plurality of communications devices associated with the subscriber; and
wherein the step of receiving identifying information of at least one candidate communications device comprises the SCP receiving, from the subscriber, an identifier of one or more of the records in the subscriber database.

47. A method in a service control point (SCP) of transferring an endpoint of an established call between two or more parties, at least one of which is a subscriber to a service provided by the SCP, from a first communications device to a second communications device of a non-subscriber transferring party, the method comprising:
the SCP receiving, from the non-subscriber transferring party, a request to transfer the call from the first device;
the SCP receiving, from the non-subscriber transferring party, identifying information of at least one candidate communications device;
the SCP initiating one or more outgoing call requests to the at least one candidate communications device;
the SCP receiving an acceptance of one of the outgoing call requests from a second communications device selected from the at least one candidate communications device; and
associating the telecommunications channel with the second communications device, and disassociating the telecommunications channel with the first communications device, in order to transfer the call.

48. A method of charging for access to a communications service wherein the communications service provides interconnection between endpoints located on disparate networks, the method comprising:
receiving an incoming call request initiated by a first subscriber from a call originating endpoint on a first communications network;
receiving, from the call originating endpoint, information identifying a call destination endpoint on a second communications network;
establishing a connection between the call originating endpoint and call destination endpoint;
metering the connection to determine an associated cost comprising one or more of: a cost associated with use of the first communications network; a cost associated with use of the second communications network; and a cost associated with provision of interconnection between the first and second networks;
determining a charge for access to the communications service by the subscriber based upon the associated cost;
in the event that the call destination endpoint is associated with a second subscriber of the communications service, applying a reduction to the determined charge; and
recording the charge in a database in association with an account record of the first subscriber.

49. The method of claim 48 wherein the reduction to the determined charge is based upon a percentage.

50. A system for caller-initiated telecommunications connection scheduling comprising:
a service control point (SCP) interfaced directly or indirectly with an Internet Protocol (IP) network and configured to accept and initiate telecommunications connections via the IP network,
wherein the SCP is further configured to:
receive a call scheduling request from a requesting subscriber, the scheduling request comprising call originating endpoint information scheduling information and call destination endpoint information, and
wherein the SCP is further configured to, in accordance with the scheduling information:
establish a first telecommunications channel with the call originating endpoint;
establish at least a second telecommunications channel with a first call destination endpoint in accordance with the call destination endpoint information; and
bridge the first and second telecommunications channels to establish a connection between the call originating endpoint and the first call destination endpoint.

51. The system of claim 50 which further comprises a database accessible via the SCP and containing calling rules associated with one or more subscribers, wherein the call destination endpoint information identifies one or more calling rules associated with the requesting subscriber, and wherein the SCP is configured to:
retrieve, from the database, the one or more associated calling rules; and
establish at least the second telecommunications channel with the first call destination endpoint in accordance with the one or more associated calling rules.

52. The system of claim 50 wherein the scheduling information indicates that the connection is to be initiated immediately.

53. The system of claim 50 wherein the scheduling information indicates that the connection is to be initiated at a specified future time.

54. The system of claim 50 wherein the scheduling information indicates that the connection is to be initiated at a plurality of specified future times.

55. The system of claim 50 further comprising a web server configured to receive call originating endpoint information scheduling information and call destination endpoint information from the subscriber via a web-based interface, and to generate and forward the call scheduling request to the SCP.

56. The system of claim 50 further comprising an SMS or instant message gateway, via which the call scheduling request is received.

57. A method of caller-initiated telecommunications connection scheduling comprising:
receiving a call scheduling request from a requesting subscriber, the scheduling request comprising call originating endpoint information scheduling information and call destination endpoint information; and
in accordance with the scheduling information:
establishing a first telecommunications channel with the call originating endpoint;
establishing at least a second telecommunications channel with a first call destination endpoint in accordance with the call destination endpoint information; and
bridging the first and second telecommunications channels to establish a connection between the call originating endpoint and the first call destination endpoint.

58. The method of claim 57 wherein the call destination endpoint information identifies one or more calling rules held within a database and associated with the requesting subscriber, and the method comprises:
retrieving, from the database, the one or more associated calling rules; and
establishing at least the second telecommunications channel with the first call destination endpoint in accordance with the one or more associated calling rules.

59. The method of claim 57 wherein the scheduling information indicates that the connection is to be initiated immediately.

60. The method of claim 57 wherein the scheduling information indicates that the connection is to be initiated at a specified future time.

61. The method of claim 57 wherein the scheduling information indicates that the connection is to be initiated at a plurality of specified future times.

62. The method of claim 57 wherein the step of receiving the call scheduling request comprises receiving call originating endpoint information scheduling information and call destination endpoint information from the subscriber via a web-based interface.

63. The method of claim 57 wherein the step of receiving the call scheduling request comprises receiving call originating endpoint information scheduling information and call destination endpoint information from the subscriber via an SMS or instant message gateway.
